(19) United States
(12) Patent Application Publication
(10) Pub. No.: US 2026/0288301 A1
(43) Pub. Date: Sep. 24, 2026

(54) Displaying a Contextualized Widget

(71) Applicant: Apple Inc., Cupertino, CA (US)

(72) Inventors: Thomas G. Salter, Foster City, CA (US); Anshu K. Chimalamarri, Sunnyvale, CA (US); Bryce L. Schmidtchen, San Francisco, CA (US); Devin W. Chalmers, Oakland, CA (US)

(21) Appl. No.: 19/695,226

(22) Filed: Jun. 2, 2026

Related U.S. Application Data
(63) Continuation of application No. 18/274,092, filed on Jan. 13, 2022.
(60) Provisional application No. 63/289,436, filed on Dec. 14, 2021.
(60) Provisional application No. 63/141,600, filed on Jan. 26, 2021.

(51) Int. Cl. G06F 3/04815; G06F 1/16; G06F 3/01; G06F 3/0346; G06F 3/16

(52) U.S. Cl. CPC G06F 3/04815; G06F 1/1694; G06F 3/013; G06F 3/0346; G06F 3/167

(57) ABSTRACT

According to various implementations, a method is performed at an electronic device with one or more processors, a non-transitory memory, a display. The electronic device optionally also includes an image sensor and input device(s). The method includes obtaining a semantic value that is associated with a physical object, based on image data. The image data is associated with a first input modality. In some implementations, the method includes obtaining a widget based on the semantic value, and displaying the widget according to an object-proximity criterion (e.g., display-locked, body-locked, or world-locked) with respect to the physical object. In some implementations, the method includes obtaining user data from the input device(s). The user data is associated with a second input modality that is different from the first input modality. Moreover, the method includes selecting a widget based on the semantic value and the user data, and displaying the widget.

### CROSS-REFERENCE TO RELATED APPLICATIONS

This application is a continuation of U.S. Patent App. No. 18/274,092, filed on July 25, 2023, which is the national stage entry of Intl. Patent App. No. PCT/US2022/012345, filed on January 13, 2022, which claims priority to U.S. Provisional Patent App No. 63/289,436, filed on December 14, 2021, and U.S. Provisional Patent App No. 63/141,600, filed on January 26, 2021, which are all hereby incorporated by reference in their entirety.

### TECHNICAL FIELD

The present disclosure relates to displaying content, and in particular displaying a widget.

### BACKGROUND

A device, with a display, may display content associated with an application. Typically, the device begins displaying content in response to receiving a user input that invokes an application, such as a user input directed to an application icon. Accordingly, display of the content is independent of a physical environment currently associated with the device. Consequently, the device does not display content that is contextualized to the physical environment, thereby providing a degraded user experience.

### SUMMARY

In accordance with some implementations, a method is performed at an electronic device with one or more processors, a non-transitory memory, and a display. The method includes obtaining a first semantic value that is associated with a first physical object. The first physical object is within a first viewable region associated with the display. The method includes obtaining a first widget that is associated with the first physical object, based on the first semantic value. The method includes displaying, on the display, the first widget according to an object-proximity criterion with respect to the first physical object.

In accordance with some implementations, a method is performed at an electronic device with one or more processors, a non-transitory memory, an image sensor, one or more input devices, and a display. The method includes obtaining, from the image sensor, image data of a physical environment. The image data is associated with a first input modality. The method includes obtaining, based on the image data, a semantic value that is associated with a physical object within the physical environment. The method includes obtaining user data from the one or more input devices. The user data is associated with a second input modality that is different from the first input modality. The method includes selecting a widget based on the semantic value and the user data. The method includes displaying the widget on the display.

In accordance with some implementations, an electronic device includes one or more processors, a non-transitory memory, an optional image sensor, optional one or more input devices, and a display. One or more programs are stored in the non-transitory memory and are configured to be executed by the one or more processors. The one or more programs may be stored in a non-transitory computer readable storage medium. The one or more programs include instructions for performing or causing performance of the operations of any of the methods described herein. In accordance with some implementations, a non-transitory computer readable storage medium has stored therein instructions which when executed by the controller of an electronic device, cause the electronic device to perform or cause performance of the operations of any of the methods described herein. In accordance with some implementations, an electronic device includes means for performing or causing performance of the operations of any of the methods described herein. In accordance with some implementations, an information processing apparatus, for use in an electronic device, includes means for performing or causing performance of the operations of any of the methods described herein.

### BRIEF DESCRIPTION OF THE DRAWINGS

For a better understanding of the various described implementations, reference should be made to the Description, below, in conjunction with the following drawings in which like reference numerals refer to corresponding parts throughout the figures.

FIG. 1 is a block diagram of an example of a portable multifunction device in accordance with some implementations.

FIG. 2 is an example of a block diagram of a system for displaying a contextualized widget in accordance with some implementations.

FIGS. 3A-3P are examples of displaying contextualized widgets in accordance with some implementations.

FIG. 4 is an example of a flow diagram of a method of displaying one or more contextualized widgets in accordance with some implementations.

FIG. 5 is an example of a flow diagram of a method of displaying a contextualized widget based on different input modalities in accordance with some implementations.

### DESCRIPTION OF IMPLEMENTATIONS

A device, with a display, may display content associated with an application. Typically, the device begins displaying content based on a user input that invokes an application. For example, a tap input directed to an application icon displayed on a touch-sensitive display triggers display of corresponding content. As another example, a double-click mouse input directed to an icon on a desktop triggers display of corresponding content. However, displaying of the content is independent of a physical environment currently associated with the device. Accordingly, neither triggering of the display of content nor modification of displayed content is a function of the physical environment currently associated with the device, resulting in a degraded user experience.

By contrast, various implementations disclosed herein include methods, electronic devices, and systems for semantically identifying a physical object in order to display a widget that is contextualized with respect to the physical object. Accordingly, the widget is tailored to a physical environment associated with a user, providing an enhanced user experience. To that end, an electronic device, including a display, obtains a semantic value associated with a physical object. The physical object is within a viewable region associated with the display. In some implementations, the electronic device utilizes a computer-vision technique in order to determine the semantic value. For example, the electronic device performs semantic segmentation (optionally with the aid of a neural network) with respect to image data that represents the physical object. The image data may be obtained from a camera that is integrated within the electronic device.

Based on the semantic value, the electronic device obtains a widget that is associated with the physical object. For example, the electronic device obtains a grocery list widget when the semantic value is “refrigerator,” because the contents of the refrigerator help to inform what grocery items should be added to the grocery list widget. In some implementations, the widget includes a status indicator. For example, the status indicator indicates the current temperature inside of an oven, the oven being viewable through the display of the electronic device. In some implementations, the widget includes a control affordance that enables modification of an operational feature of an electronic device. For example, when the semantic value is “screw head” a widget includes a flashlight affordance, which, when selected, turns on a flashlight integrated in the electronic device. By providing illumination via the flashlight, the electronic device aids a user in positioning a screwdriver onto the screw head in a relatively dark physical environment.

The electronic device displays the widget according to an object-proximity criterion with respect to the physical object. For example, in some implementations, the electronic device displays the widget when the physical object is within a current viewable region associated with the display. As another example, in some implementations, the electronic device displays the widget when the physical object is outside of a current viewable region but less than a threshold distance from the current viewable region. As yet another example, in some implementations, the object-proximity criterion corresponds to displaying the widget as one of display-locked, body-locked, or world-locked.

A display-locked object (sometimes referred to herein as a “head-locked object”) is locked to particular position of the display. For example, a display-locked object corresponds to a heads-up display (HUD) that is display locked to slightly above the center point of a display. Accordingly, in response to a change in pose (e.g., a rotation or translational movement) of an electronic device, the electronic device maintains display of the display-locked object at the particular position of the display. In contrast to a world-locked object, the position of the display-locked object is independent of a current physical environment that is associated with the electronic device. Although at a given time the displayed-object is locked to a particular position of the display, the particular position may be changed. For example, in response to receiving a user input, an electronic device moves a menu from being locked to the upper right corner of the display to being locked to the upper left corner of the display.

A body-locked object is locked to a portion of a body of a user. For example, a head-mountable device (HMD) maintains display of the body-locked object at a particular distance (e.g., depth) from the portion of the body of the user and at a particular angular offset with respect to the portion of the body of the user. For example, a timer widget is body-locked at one meter away from the torso of the user and at 45 degrees left of the center of the torso. Initially, the HMD, worn by a user, displays the timer widget so as to appear to be one meter away from the torso, at 45 degrees left of the center of the torso. Continuing with this example, while the torso is stationary, the head of the user and the HMD turn leftwards, and the HMD detects the leftwards rotation (e.g., via an IMU). In response to detecting the leftwards rotation, the HMD correspondingly moves the timer widget rightwards on the display in order to maintain the timer widget at 45 degrees left of the center of the torso. Accordingly, in contrast to a display-locked object, the position of the body-locked object on the display may change based on a rotational change of the HMD. As another example, in response to detecting a translational movement (e.g., the user walks to a different room in a house), the HMD maintains the body-locked object at the particular distance from the portion of the body of the user and at the particular angular offset with respect to the portion of the body of the user. Accordingly, in contrast to a world-locked object, the HMD displays the body-locked object so as to appear to follow the HMD based on a translational movement of the HMD.

A world-locked object is locked to a volumetric region or a specific point of a particular physical environment. Accordingly, the world-locked object is displayed when a viewable region associated with the display includes the volumetric region or the specific point. In response to a pose change of the electronic device, the appearance of the world-locked object changes. For example, in response to a rotation of the electronic device, the world-locked object moves to a different location on the display or ceases to be displayed. As another example, as the electronic devices moves towards the world-locked object, the world-locked objects appear larger. Although at a given time the world-locked object is locked to a volumetric region, the volumetric region may be changed. For example, based on one or more user inputs, the electronic device selects and moves a computer-generated couch to a different location within a living room.

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described implementations. The first contact and the second contact are both contacts, but they are not the same contact, unless the context clearly indicates otherwise.

The terminology used in the description of the various described implementations herein is for the purpose of describing particular implementations only and is not intended to be limiting. As used in the description of the various described implementations and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including”, “comprises”, and/or “comprising”, when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting”, depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]”, depending on the context.

A person can interact with and/or sense a physical environment or physical world without the aid of an electronic device. A physical environment can include physical features, such as a physical object or surface. An example of a physical environment is physical forest that includes physical plants and animals. A person can directly sense and/or interact with a physical environment through various means, such as hearing, sight, taste, touch, and smell. In contrast, a person can use an electronic device to interact with and/or sense an extended reality (XR) environment that is wholly or partially simulated. The XR environment can include mixed reality (MR) content, augmented reality (AR) content, virtual reality (VR) content, and/or the like. With an XR system, some of a person’s physical motions, or representations thereof, can be tracked and, in response, characteristics of virtual objects simulated in the XR environment can be adjusted in a manner that complies with at least one law of physics. For instance, the XR system can detect the movement of a user’s head and adjust graphical content and auditory content presented to the user similar to how such views and sounds would change in a physical environment. In another example, the XR system can detect movement of an electronic device that presents the XR environment (e.g., a mobile phone, tablet, laptop, or the like) and adjust graphical content and auditory content presented to the user similar to how such views and sounds would change in a physical environment. In some situations, the XR system can adjust characteristic(s) of graphical content in response to other inputs, such as a representation of a physical motion (e.g., a vocal command).

Many different types of electronic systems can enable a user to interact with and/or sense an XR environment. A non-exclusive list of examples include heads-up displays (HUDs), head mountable systems, projection-based systems, windows or vehicle windshields having integrated display capability, displays formed as lenses to be placed on users’ eyes (e.g., contact lenses), headphones/earphones, input systems with or without haptic feedback (e.g., wearable or handheld controllers), speaker arrays, smartphones, tablets, and desktop/laptop computers. A head mountable system can have one or more speaker(s) and an opaque display. Other head mountable systems can be configured to accept an opaque external display (e.g., a smartphone). The head mountable system can include one or more image sensors to capture images/video of the physical environment and/or one or more microphones to capture audio of the physical environment. A head mountable system may have a transparent or translucent display, rather than an opaque display. The transparent or translucent display can have a medium through which light is directed to a user’s eyes. The display may utilize various display technologies, such as uLEDs, OLEDs, LEDs, liquid crystal on silicon, laser scanning light source, digital light projection, or combinations thereof. An optical waveguide, an optical reflector, a hologram medium, an optical combiner, combinations thereof, or other similar technologies can be used for the medium. In some implementations, the transparent or translucent display can be selectively controlled to become opaque. Projection-based systems can utilize retinal projection technology that projects images onto users’ retinas. Projection systems can also project virtual objects into the physical environment (e.g., as a hologram or onto a physical surface).

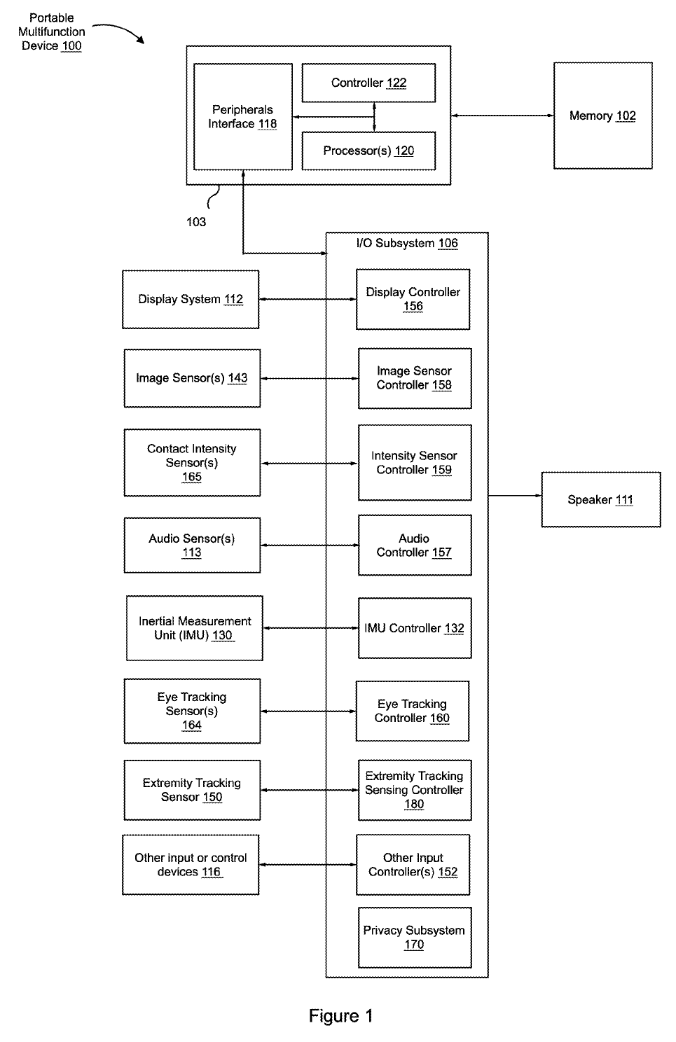

FIG. 1 is a block diagram of an example of a portable multifunction device 100 (sometimes also referred to herein as the “electronic device 100” for the sake of brevity) in accordance with some implementations. The electronic device 100 includes memory 102 (which optionally includes one or more computer readable storage mediums), a memory controller 122, one or more processing units (CPUs) 120, a peripherals interface 118, an input/output (I/O) subsystem 106, a speaker 111, a display system 112, an inertial measurement unit (IMU) 130, image sensor(s) 143 (e.g., camera), contact intensity sensor(s) 165, audio sensor(s) 113 (e.g., microphone), eye tracking sensor(s) 164 (e.g., included within a head-mountable device (HMD)), an extremity tracking sensor 150, and other input or control device(s) 116. In some implementations, the electronic device 100 corresponds to one of a mobile phone, tablet, laptop, wearable computing device, head-mountable device (HMD), head-mountable enclosure (e.g., the electronic device 100 slides into or otherwise attaches to a head-mountable enclosure), or the like. In some implementations, the head-mountable enclosure is shaped to form a receptacle for receiving the electronic device 100 with a display.

In some implementations, the peripherals interface 118, the one or more processing units 120, and the memory controller 122 are, optionally, implemented on a single chip, such as a chip 103. In some other implementations, they are, optionally, implemented on separate chips.

The I/O subsystem 106 couples input/output peripherals on the electronic device 100, such as the display system 112 and the other input or control devices 116, with the peripherals interface 118. The I/O subsystem 106 optionally includes a display controller 156, an image sensor controller 158, an intensity sensor controller 159, an audio controller 157, an eye tracking controller 160, one or more input controllers 152 for other input or control devices, an IMU controller 132, an extremity tracking controller 180, and a privacy subsystem 170. The one or more input controllers 152 receive/send electrical signals from/to the other input or control devices 116. The other input or control devices 116 optionally include physical buttons (e.g., push buttons, rocker buttons, etc.), dials, slider switches, joysticks, click wheels, and so forth. In some alternate implementations, the one or more input controllers 152 are, optionally, coupled with any (or none) of the following: a keyboard, infrared port, Universal Serial Bus (USB) port, stylus, finger-wearable device, and/or a pointer device such as a mouse. The one or more buttons optionally include an up/down button for volume control of the speaker 111 and/or audio sensor(s) 113. The one or more buttons optionally include a push button. In some implementations, the other input or control devices 116 includes a positional system (e.g., GPS) that obtains information concerning the location and/or orientation of the electronic device 100 relative to a particular object. In some implementations, the other input or control devices 116 include a depth sensor and/or a time-of-flight sensor that obtains depth information characterizing a particular object.

The display system 112 provides an input interface and an output interface between the electronic device 100 and a user. The display controller 156 receives and/or sends electrical signals from/to the display system 112. The display system 112 displays visual output to the user. The visual output optionally includes graphics, text, icons, video, and any combination thereof (collectively termed “graphics”). In some implementations, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

The display system 112 may have a touch-sensitive surface, sensor, or set of sensors that accepts input from the user based on haptic and/or tactile contact. The display system 112 and the display controller 156 (along with any associated modules and/or sets of instructions in the memory 102) detect contact (and any movement or breaking of the contact) on the display system 112 and converts the detected contact into interaction with user-interface objects (e.g., one or more soft keys, icons, web pages or images) that are displayed on the display system 112. In an example implementation, a point of contact between the display system 112 and the user corresponds to a finger of the user or a finger-wearable device.

In some implementations, the display system 112 corresponds to a display integrated in a head-mountable device (HMD), such as AR glasses. For example, the display system 112 includes a stereo display (e.g., stereo pair display) that provides (e.g., mimics) stereoscopic vision for eyes of a user wearing the HMD.

The display system 112 optionally uses LCD (liquid crystal display) technology, LPD (light emitting polymer display) technology, or LED (light emitting diode) technology, although other display technologies are used in other implementations. The display system 112 and the display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with the display system 112.

The user optionally makes contact with the display system 112 using any suitable object or appendage, such as a stylus, a finger-wearable device, a finger, and so forth. In some implementations, the user interface is designed to work with finger-based contacts and gestures, which can be less precise than stylus-based input due to the larger area of contact of a finger on the touch screen. In some implementations, the electronic device 100 translates the rough finger-based input into a precise pointer/cursor position or command for performing the actions desired by the user.

The speaker 111 and the audio sensor(s) 113 provide an audio interface between a user and the electronic device 100. Audio circuitry receives audio data from the peripherals interface 118, converts the audio data to an electrical signal, and transmits the electrical signal to the speaker 111. The speaker 111 converts the electrical signal to human-audible sound waves. Audio circuitry also receives electrical signals converted by the audio sensors 113 (e.g., a microphone) from sound waves. Audio circuitry converts the electrical signal to audio data and transmits the audio data to the peripherals interface 118 for processing. Audio data is, optionally, retrieved from and/or transmitted to the memory 102 and/or RF circuitry by the peripherals interface 118. In some implementations, audio circuitry also includes a headset jack. The headset jack provides an interface between audio circuitry and removable audio input/output peripherals, such as output-only headphones or a headset with both output (e.g., a headphone for one or both ears) and input (e.g., a microphone).

The inertial measurement unit (IMU) 130 includes accelerometers, gyroscopes, and/or magnetometers in order measure various forces, angular rates, and/or magnetic field information with respect to the electronic device 100. Accordingly, according to various implementations, the IMU 130 detects one or more positional change inputs of the electronic device 100, such as the electronic device 100 being shaken, rotated, moved in a particular direction, and/or the like.

The image sensor(s) 143 capture still images and/or video. In some implementations, an image sensor 143 is located on the back of the electronic device 100, opposite a touch screen on the front of the electronic device 100, so that the touch screen is enabled for use as a viewfinder for still and/or video image acquisition. In some implementations, another image sensor 143 is located on the front of the electronic device 100 so that the user's image is obtained (e.g., for selfies, for videoconferencing while the user views the other video conference participants on the touch screen, etc.). In some implementations, the image sensor(s) are integrated within an HMD.

The contact intensity sensors 165 detect intensity of contacts on the electronic device 100 (e.g., a touch input on a touch-sensitive surface of the electronic device 100). The contact intensity sensors 165 are coupled with the intensity sensor controller 159 in the I/O subsystem 106. The contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). The contact intensity sensor(s) 165 receive contact intensity information (e.g., pressure information or a proxy for pressure information) from the physical environment. In some implementations, at least one contact intensity sensor 165 is collocated with, or proximate to, a touch-sensitive surface of the electronic device 100. In some implementations, at least one contact intensity sensor 165 is located on the side of the electronic device 100.

The eye tracking sensor(s) 164 detect eye gaze of a user of the electronic device 100 and generate eye tracking data indicative of the eye gaze of the user. In various implementations, the eye tracking data includes data indicative of a fixation point (e.g., point of regard) of the user on a display panel, such as a display panel within a head-mountable device (HMD), a head-mountable enclosure, or within a heads-up display.

The extremity tracking sensor 150 obtains extremity tracking data indicative of a pose of an extremity of a user. For example, in some implementations, the extremity tracking sensor 150 corresponds to a hand tracking sensor that obtains hand tracking data indicative of a position, orientation, or both of a hand or a finger of a user within a particular object. In some implementations, the extremity tracking sensor 150 utilizes computer vision techniques to estimate the pose of the extremity based on camera images.

In various implementations, the electronic device 100 includes a privacy subsystem 170 that includes one or more privacy setting filters associated with user information, such as user information included in extremity tracking data, eye gaze data, and/or body position data associated with a user. In some implementations, the privacy subsystem 170 selectively prevents and/or limits the electronic device 100 or portions thereof from obtaining and/or transmitting the user information. To this end, the privacy subsystem 170 receives user preferences and/or selections from the user in response to prompting the user for the same. In some implementations, the privacy subsystem 170 prevents the electronic device 100 from obtaining and/or transmitting the user information unless and until the privacy subsystem 170 obtains informed consent from the user. In some implementations, the privacy subsystem 170 anonymizes (e.g., scrambles or obscures) certain types of user information. For example, the privacy subsystem 170 receives user inputs designating which types of user information the privacy subsystem 170 anonymizes. As another example, the privacy subsystem 170 anonymizes certain types of user information likely to include sensitive and/or identifying information, independent of user designation (e.g., automatically).

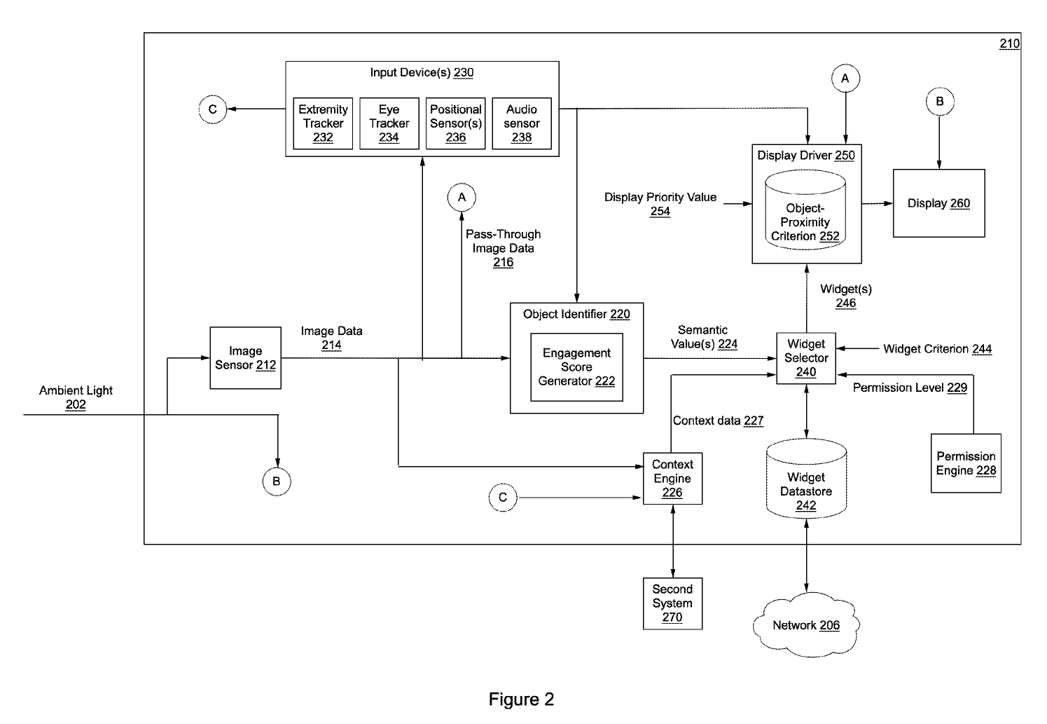

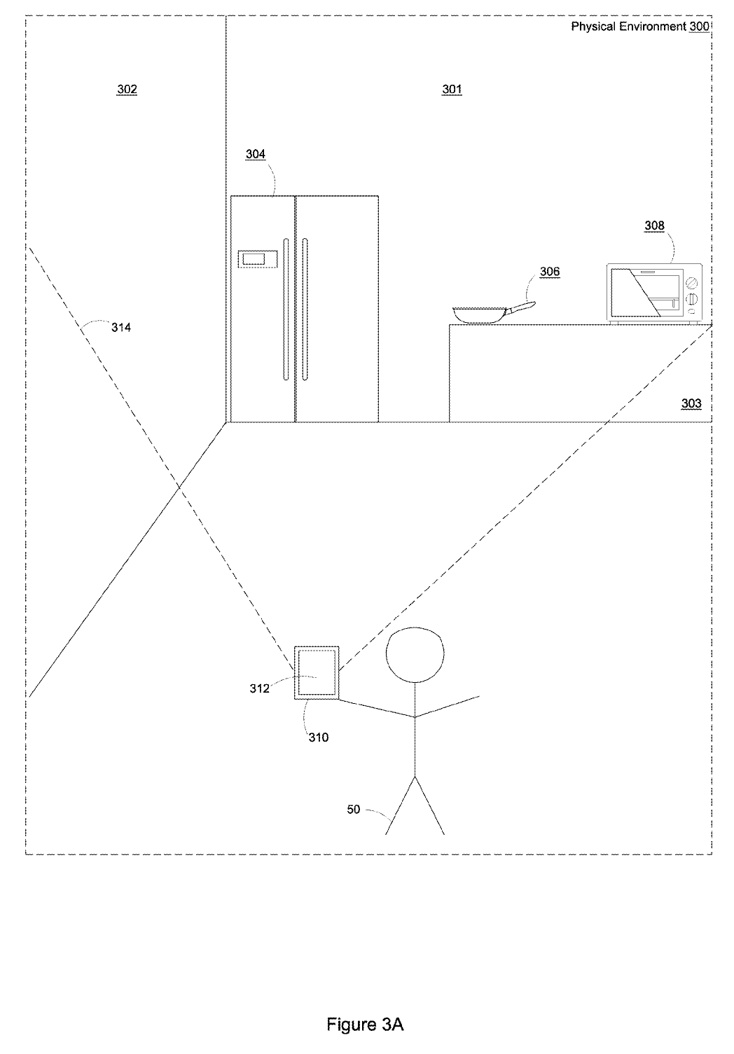

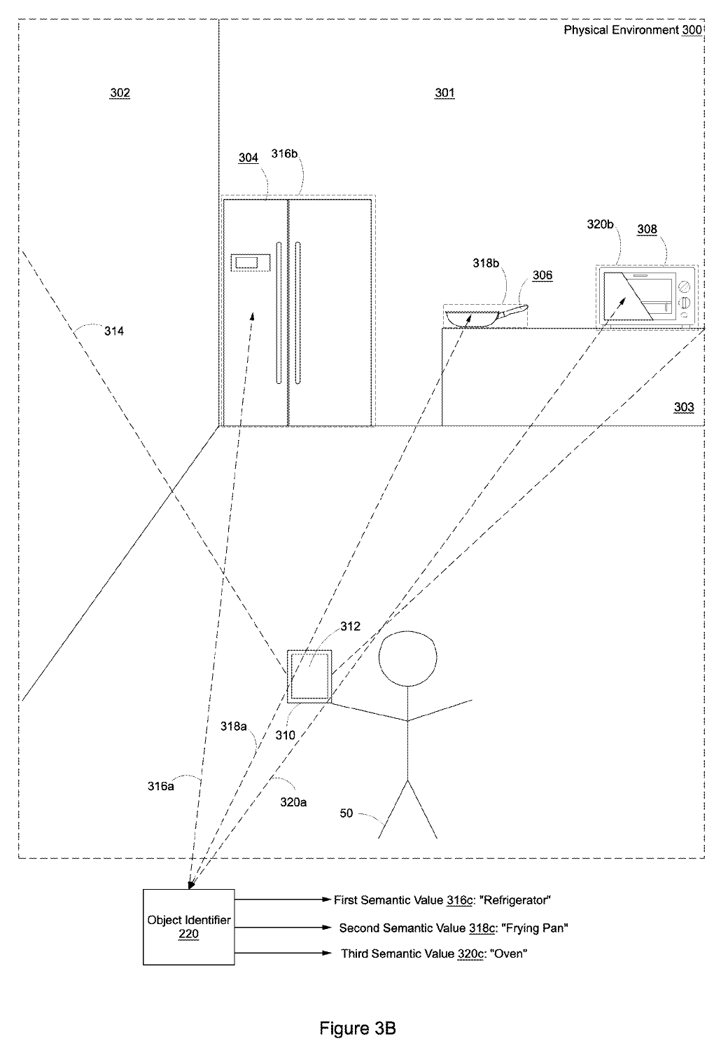

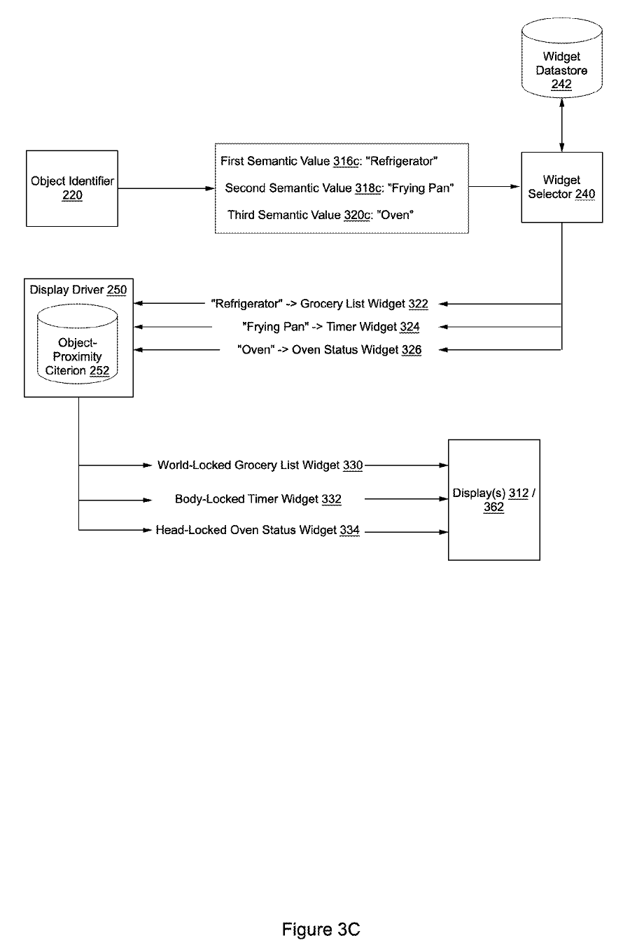

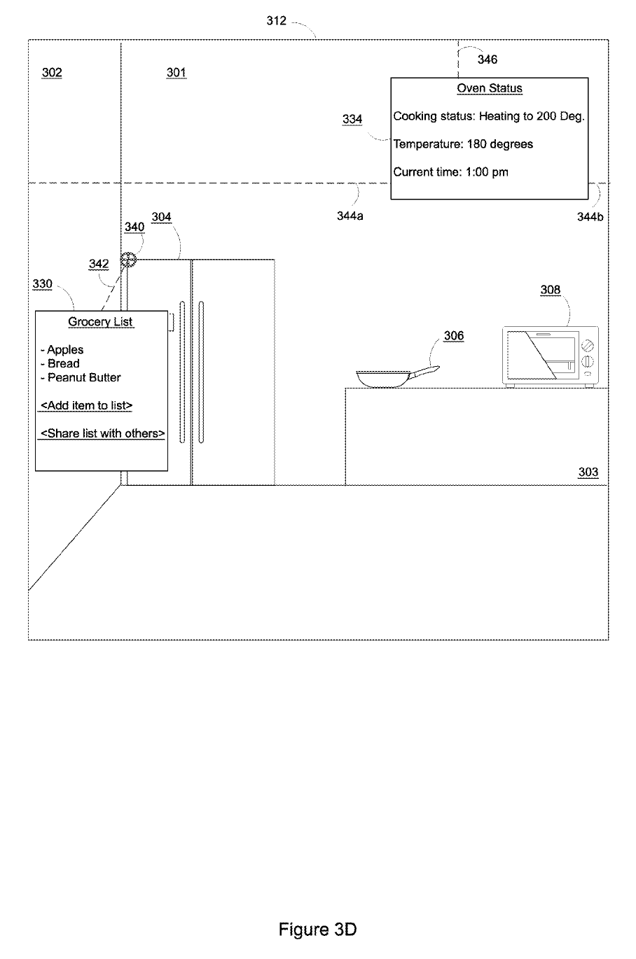

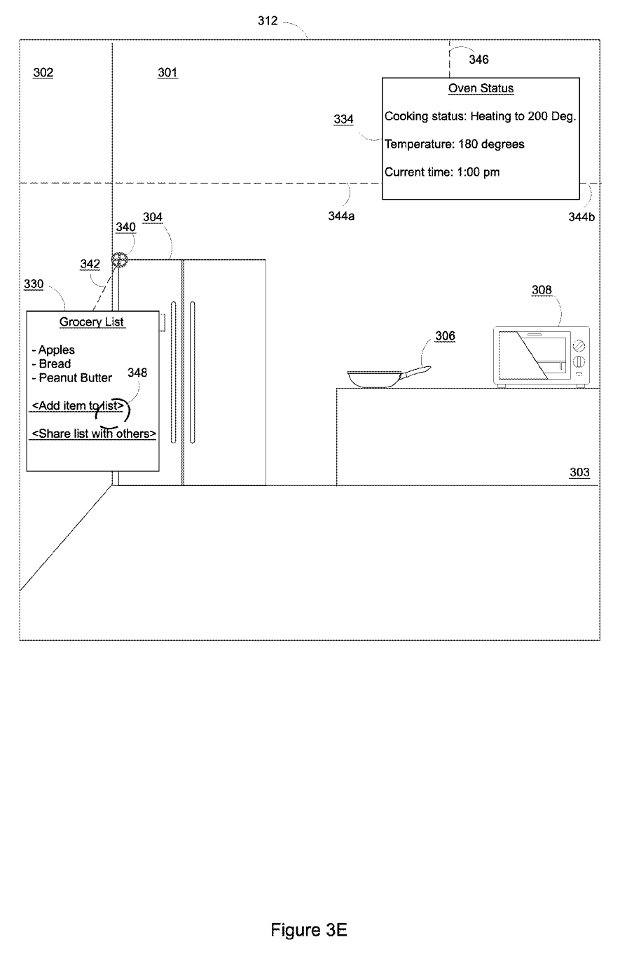

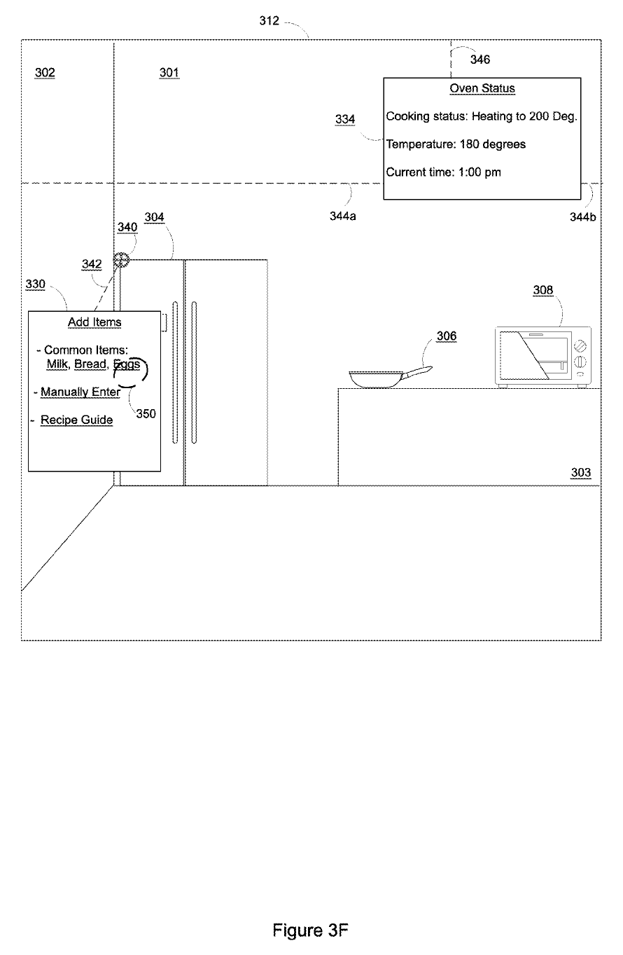

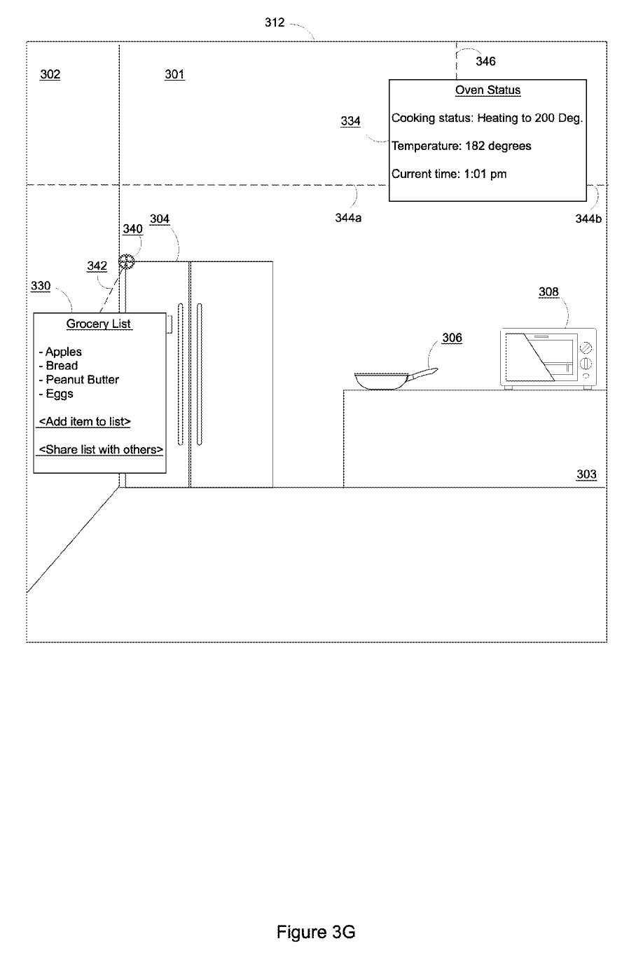

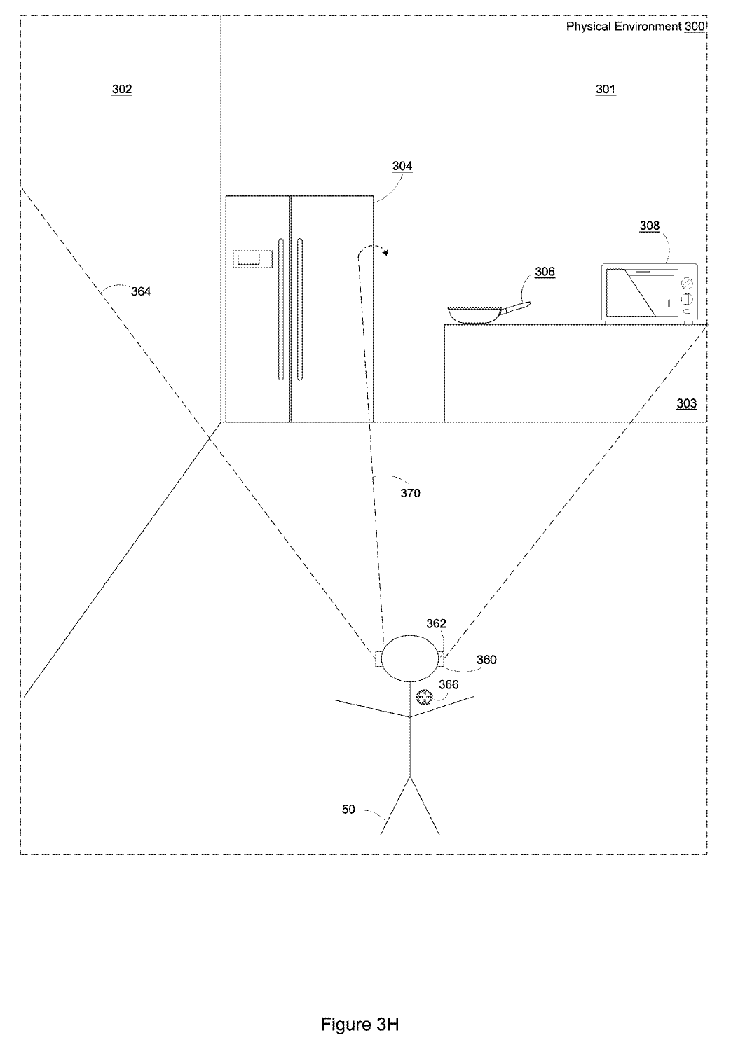

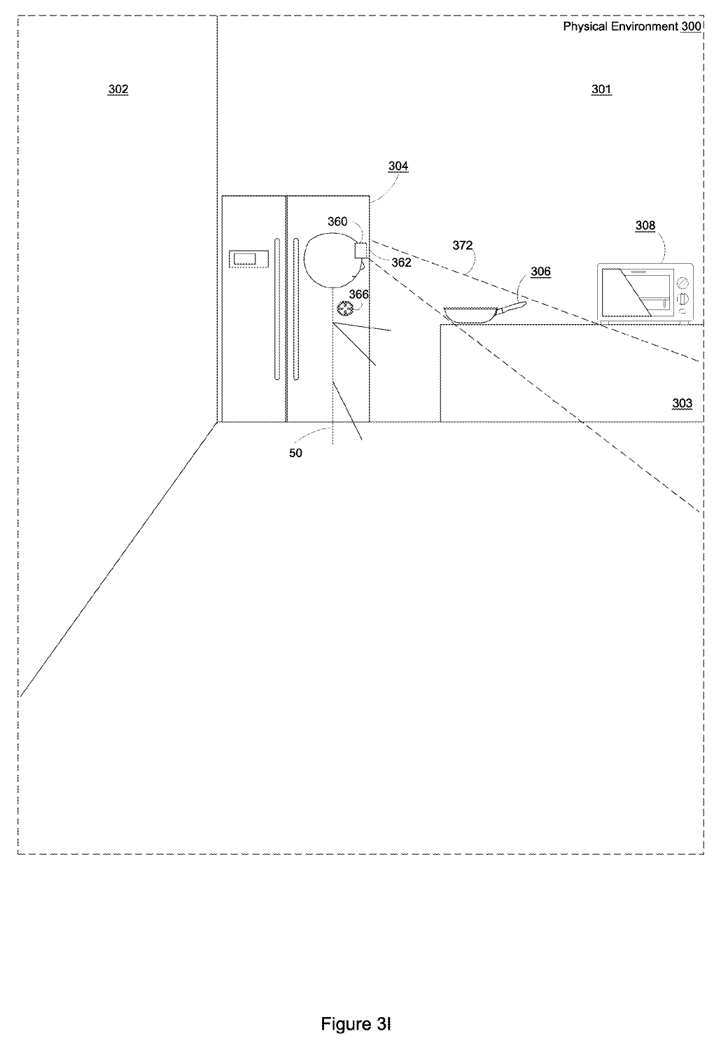

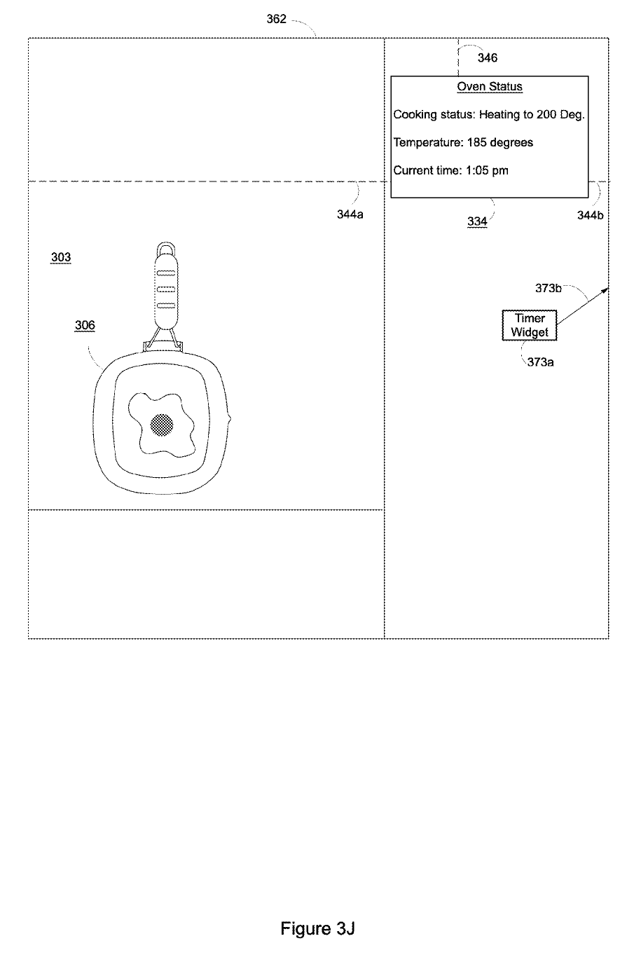

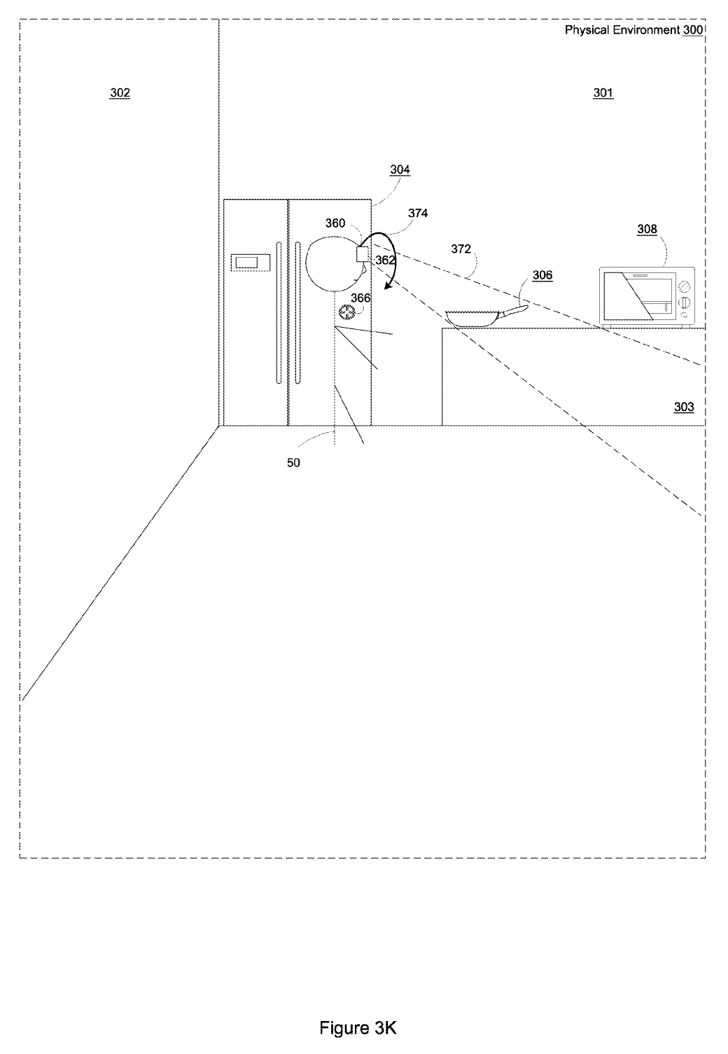

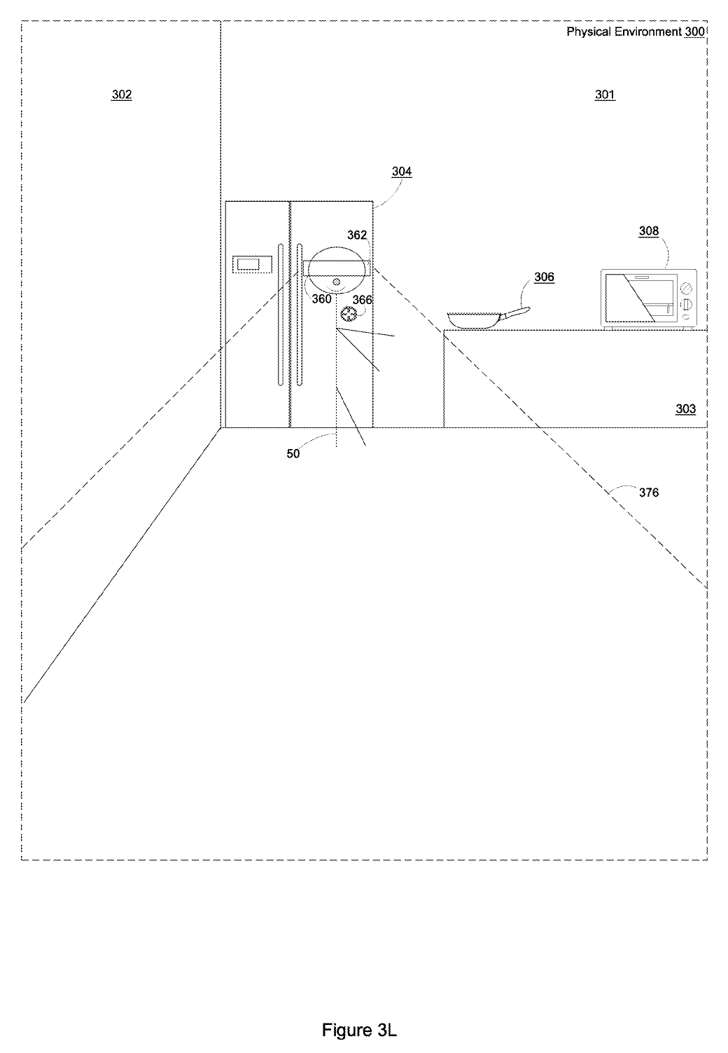

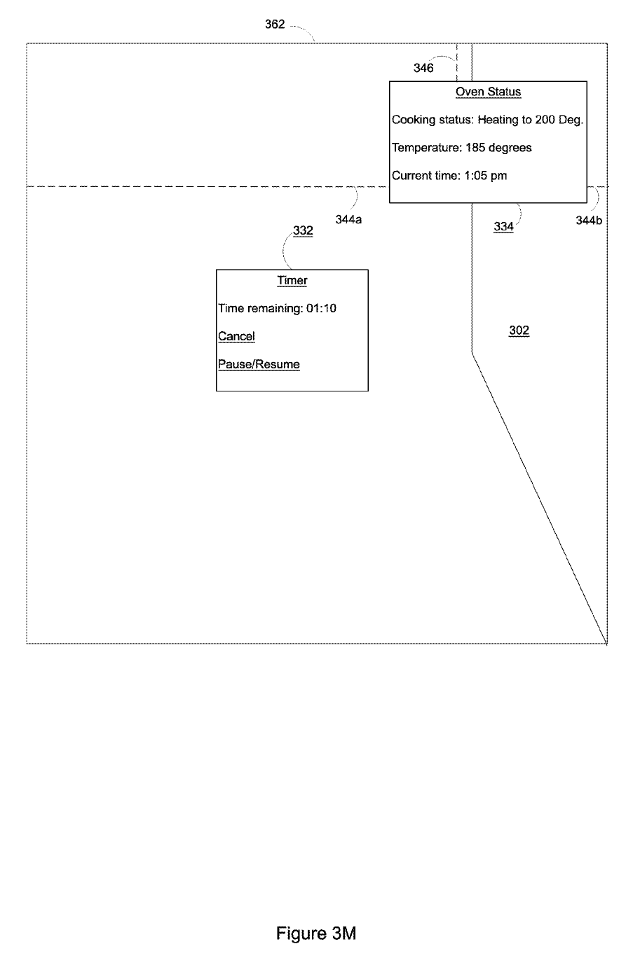

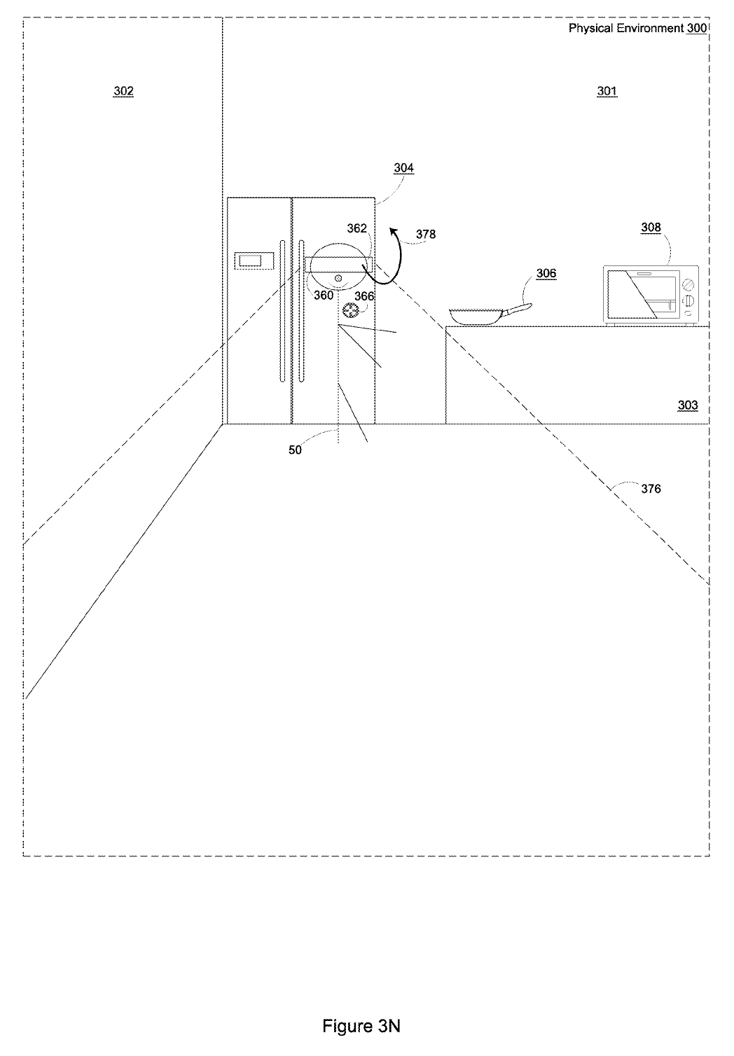

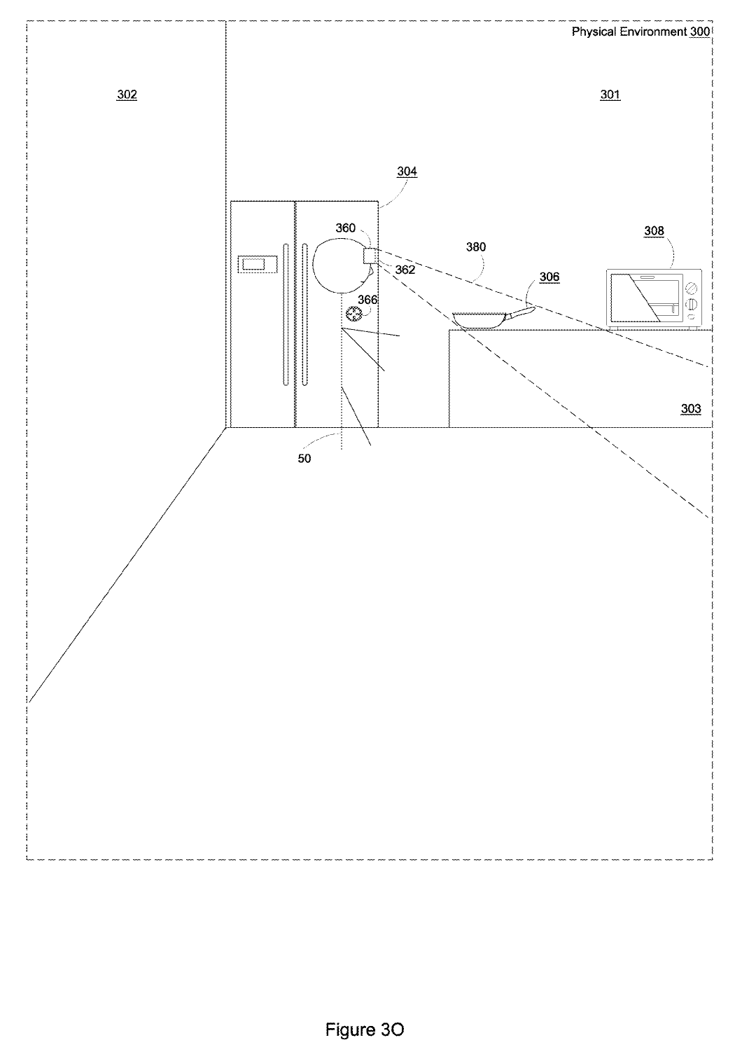

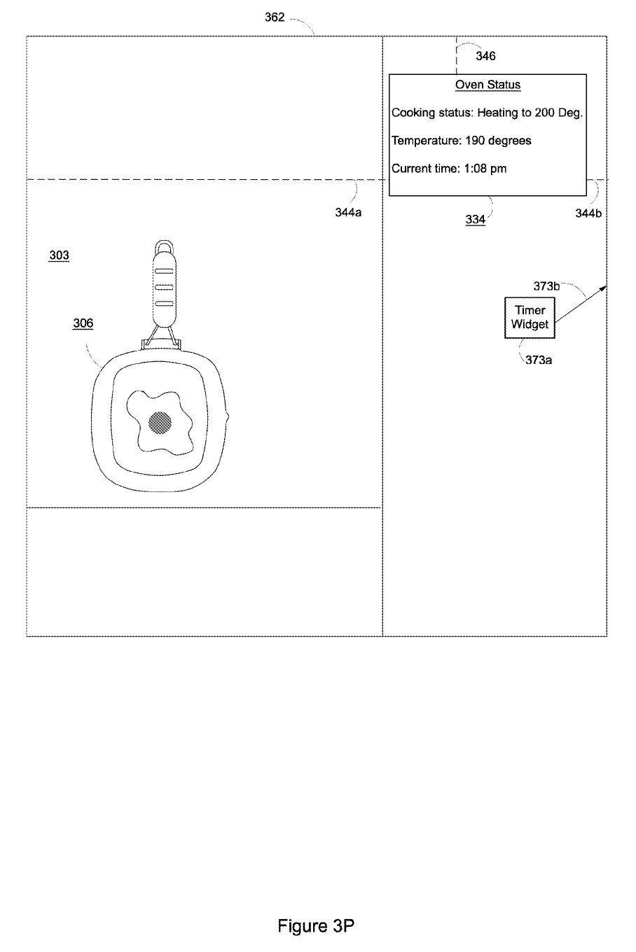

FIG. 2 is an example of a block diagram of a system 210 for displaying, on a display 260, a contextualized widget in accordance with some implementations. According to various implementations, the system 210 or portions thereof is integrated in an electronic device (e.g., the electronic device 100 in FIG. 1 or the electronic device 310 in FIGS. 3A-3G). According to various implementations, the system 210 or portions thereof is integrated in a head-mountable device (HMD), such as the HMD 360 in FIGS. 3H-3P. While pertinent features of the system 210 are shown, those of ordinary skill in the art will appreciate from the present disclosure that various other features have not been illustrated for the sake of brevity and so as not to obscure more pertinent aspects of the example implementations disclosed herein.

In some implementations, the system 210 includes an image sensor 212 (e.g., a front facing camera). The image sensor 212 outputs image data 214 based on ambient light 202 from a physical (e.g., real-world) environment. For example, in some implementations, the image data 214 corresponds to a still image of the physical environment. As another example, in some implementations, the image data 214 includes a series of sequential images, such as a video stream of the physical environment. In some implementations, the system 210 provides the image data 214 as pass-through image data 216 to a display driver 250, which drives the display 260 with the pass-through image data 216. Moreover, the display driver 250 composites one or more widgets 246 with the pass-through image data 216.

In some implementations, the display 260 corresponds to a see-through display, such as a transparent display. The see-through display is sometimes referred to as an additive display. Accordingly, rather than displaying pass-through image data, the ambient light 202 is incident on and thus presented on the see-through display. Moreover, the display driver 250 adds to the ambient light 202 presented on the see-through display, one or more widgets 246.

In some implementations, the system 210 includes an object identifier 220. Based on the image data 214, the object identifier 220 semantically identifies one or more physical objects that are within a viewable region associated with the display 260. For example, the object identifier 220 performs semantic segmentation (optionally with the aid of a neural network) with respect to the image data 214 in order to identify a particular physical object represented within the image data 214. Based on the identification, the object identifier 220 determines one or more semantic values 224 respectively associated with the one or more physical objects.

In some implementations, the object identifier 220 outputs the one or more semantic values 224 based on a function of one or more corresponding engagement scores. The one or more engagement scores characterize a level of user engagement with respect to the one or more physical objects. To that end, the object identifier 220 may include an engagement score generator 222 that determines the one or more corresponding engagement scores based on data from one or more input devices 230. For example, in some implementations, based on eye tracking data from an eye tracker 234, the engagement score generator 222 determines a first engagement score of 0.8 associated with a physical oven because a user is gazing at the physical oven, and determines a second engagement score of 0.0 associated with a physical doorknob because the user is not gazing at the physical doorknob. Continuing with this example, the object identifier 220 provides, to a widget selector 240, a first semantic value of “oven” associated with the physical oven because the first engagement score of 0.8 exceeds a threshold value of 0.5. On the other hand, the object identifier 220 foregoes providing a second semantic value of “doorknob” to the widget selector 240 because the second engagement score of 0.0 does not exceed the threshold value of 0.5. Selectively providing semantic values to the widget selector 240 saves memory and processing resource utilization associated with the widget selector 240 selecting and retrieving corresponding widgets.

In some implementations, in addition to or instead of utilizing the eye tracking data, the engagement score generator 222 determines the one or more corresponding engagement scores based on extremity tracking data from an extremity tracker 232 and/or positional data from one or more positional sensors 236. The positional data characterizes a current pose of (e.g., orientation, position, or both) and/or pose change of (e.g., rotation, translational movement) the system 210. Examples of the one or more positional sensors 236 include a simultaneous localization and mapping (SLAM) sensor, a visual inertial odometry (VIO) sensor, inertial measurement unit (IMU) sensor, etc.

According to various implementations, the widget selector 240 selects one or more widgets 246 and obtains the one or more widgets 246, based on the one or more semantic values 224. The widget selector 240 provides the one or more widgets 246 to a display driver 250. The display driver 250 drives the display 260 to display the one or more widgets 246, based on a function of an object-proximity criterion 252. Operation of the display driver 250 is described below.

In some implementations, the widget selector 240 selects a particular widget based on text-based matching. For example, the widget selector 240 identifies a particular widget that is associated with a widget name, wherein the widget name matches at least a portion of a semantic value. As one example, the widget selector 240 obtains a semantic value of “oven,” and the widget selector 240 selects a widget named “oven timer” because the widget name of “oven timer” includes the semantic value of “oven.”

In some implementations, the widget selector 240 identifies a particular widget based on metadata associated with the particular widget. For example, the widget selector 240 obtains a semantic value of “refrigerator.” Continuing with this example, the widget selector 240 selects a grocery list widget because the grocery list widget is associated with metadata that indicates that the grocery list widget is suitable for use with a food container, such as a refrigerator, kitchen pantry, fruit bowl, etc.

In some implementations, the widget selector 240 selects a particular widget based on a semantic value and a widget criterion 244. For example, the widget criterion 244 may be a function of a user profile, current or historical user activity, popular (e.g., trending) widgets, etc. As one example, the user profile indicates a user’s hobbies include cooking, and thus the system 210 biases the widget selector 240 to obtain a cooking widget. As another example, the user profile may indicate a history of interaction with a device, such as whether a remotely controllable electronic device (e.g., a thermostat, TV, oven, etc.) was previously used by the user, was setup by the user, etc. In this example, widget selector 240 may be more likely to present as a corresponding widget for controlling the electronic device when a history of interactions exists.

In some implementations, the widget selector 240 obtains the one or more widgets 246 from a widget datastore 242, which may be allocated within a local memory storage. To that end, in some implementations, the system 210 obtains the one or more widgets 246 via a network 206 and stores the one or more widgets 246 in the widget datastore 242. For example, the system 210 downloads or streams the one or more widgets 246 from the Internet. In some implementations, an application having a widget stored within widget datastore 242 may be associated with a single widget. For example, a timer application may present the user with a timer widget having the same appearance and functionality regardless of the context in which it is selected or displayed. In other implementations an application having a widget stored within widget datastore 242 may be associated with more than one widget that have the same or different appearance and functionality. For example, a nutrition application may present the user with a widget that allows a user to log caffeine consumption in response to semantic value(s) 224 including a “coffee cup.” However, this same nutrition application may present the user with a widget that allows the user to view nutritional information in response to semantic value(s) 224 including an “apple” or a widget that allows the user to manually enter nutritional information in response to semantic value(s) 224 including an “unknown food.” Widget selector 240 may select the appropriate widget from multiple application widgets based on definitions provided by the application, user, system (e.g., operating system of device 100), user of device 100, or a user of another mobile device to which the user of device 100 has given permission.

In some implementations, the system 210 includes a context engine 226 that determines context data 227 and provides the context data 227 to the widget selector 240. In some implementations, the context engine 226 determines the context data 227 by performing computer vision with respect to the image data 214. The context data 227 may indicate one or more context values. For example, the context data 227 indicates a scene type, such as indoors versus outdoors. As another example, the scene type indicates a room type, such as kitchen, garage, office, etc. As one example, when the semantic value(s) 224 include a “frying pan,” and the context data 227 indicates a kitchen, the widget selector 240 selects a timer widget. As another example, when the semantic value(s) 224 include the “frying pan,” and the context data 227 indicates a cookware retailer store, the widget selector 240 selects a web browser application, including a webpage with search results of prices of the frying pan at other stores.

In some implementations, the context data 227 may include a current activity of a user determined by context engine 226 based on input devices 230, image data 214, or other sensor data. For example, the context data 227 may indicate that the user is riding a bicycle, walking, eating, sitting, or the like. As one example, when semantic value(s) 224 include an “apple,” and the context data 227 indicates that the user is eating, the widget selector 240 may select a calorie tracker widget. As another example, when the semantic value(s) 224 include a “TV,” and the context data 227 indicates that the user is sitting, the widget selector 240 may select a widget for controlling the TV. In some examples, the widget for controlling the TV may be displayed in the user’s field of view such that it does not occlude a portion of the TV display.

In some implementations, the context data 227 may include people that are present with the user determined by context engine 226 based on input devices 230, image data 214, or other sensor data. For example, the context data 227 may indicate that the user is collocated with a friend, co-worker, family member, or the like. As one example, when semantic value(s) 224 include a “desk,” and the context data 227 indicates that the user is with a coworker, the widget selector 240 may select a whiteboard application widget. As another example, when the semantic value(s) 224 include a “loudspeaker,” and the context data 227 indicates that the user is with a friend, the widget selector 240 may select a music application widget.

In some implementations, the context data 227 is based on audio data from an audio sensor 238. The audio data may include sounds produced by a user of the system 210. For example, based on the audio data, the context engine 226 determines context data 227 indicating that the user is brushing his or her teeth. Accordingly, the widget selector 224 may select a timer widget in order to aid the user in brushing teeth for a sufficient amount of time.

In some implementations, the context engine 226 determines the context data 227 based on user data from the input device(s) 230. For example, an eye (tracked via the eye tracker 234) or an extremity (tracked via the extremity tracker 232) is directed to a widget interface. The widget interface may enable a user to associate certain contexts with certain widgets. For example, a user may designate a first set of appropriate widgets for outdoor contexts (e.g., a park), and may designate a second set of appropriate widgets for indoor contexts (e.g., a kitchen).

In some implementations, the context engine 226 determines the context data 227 based on data from a second system 270. For example, the system 210 is integrated in a first mobile device (e.g., a first smartphone), and the second system 270 is integrated in a second mobile device (e.g., a second smartphone). To that end, in some implementations, the system 210 includes a communication interface provided to enable communication with the second system 270. The communication interface may correspond to a Bluetooth interface, a cellular data interface, a Wi-Fi interface, a near-field communication (NFC) interface, etc. As one example, the system 210 receives from the second system 270, a message indicating relationships between contexts and appropriate widgets. For example, the message is tailored to certain scene types associated with a user of the second system 270, such as various rooms of a house of the user. As one example, the message indicates a first set of appropriate widgets for a kitchen, a second set of appropriate widgets for a garage, a third set of appropriate widgets for a living room, etc. Accordingly, when the system 210 enters the garage of the house of the user of the second system 270, the context data 227 indicates the first set of appropriate widgets, and the widget selector 240 selects one of the first set of appropriate widgets.

In some implementations, the system 210 includes a permission engine 228 that provides, to the widget selector 240, a permission level 229 associated with a current user of the system 210. The widget selector 240 may select a particular widget based on the permission level 229. In some implementations, the permission level 229 is set on a per-user (e.g., individualized) basis. For example, the widget selector 240 selects from among a first set of widgets for a first user having a first permission level, and the widget selector 240 selects from among a second set of widgets for a second user having a second (different) permission level. In some implementations, the permission level 229 is based on a characteristic or profile of the current user. For example, when the user is an adult, the permission level 229 is higher than for when the user is a child. Accordingly, the widget selector 240 may select from among a larger set of widgets for the adult than for the child. As another example, the permission level 229 associated with a doctor allows the widget selector 240 to select a notes widget including notes of the doctor, whereas the permission level 229 associated with a patient of the doctor blocks the widget selector 240 from selecting the notes widget.

In some implementations, widget selector 240 may select a widget based on the semantic value(s) 224, context data 227, widget criterion 244, permission level 229, or any combination thereof. As an example, the widget criterion 244 may include user-defined criteria that indicates a widget for a particular application (e.g., a shared notes application widget) should be selected when semantic value(s) 224 includes a particular object (e.g., a refrigerator), context data 227 indicates that the user is in a particular location (e.g., the kitchen), and the permission level 229 indicates that the user has permission to view the widget. In this example, the shared notes application widget may display notes made by the user as well as those made by other users having the appropriate level of permission to access the widget or application. In other examples, the selection of a particular application widget or selection of a widget from multiple widgets of the same application may be defined by the application(s), system (e.g., operating system of device 100), user of device 100, or a user of another mobile device to which the user of device 100 has given permission.

According to various implementations, the display driver 250 drives the display 260 with the one or more widgets 246 from the widget selector 240, according to an object-proximity criterion 252 with respect to one or more physical objects associated with the one or more widgets 246. As described with reference to FIGS. 3A-3P, in some implementations, the object-proximity criterion 252 corresponds to driving the display of a particular widget as one of display-locked, body-locked, or world-locked. To that end, in some implementations, the display driver 250 utilizes positional sensor data from the positional sensor 236 in order to drive the display 260 to display a particular widget as world-locked to a corresponding physical object. For example, the object identifier 220 performs a combination of SLAM and semantic segmentation in order to determine a 3D anchor within an environment, and the display driver 250 displays a particular world-locked object as world-locked to the 3D anchor. The object identifier 220 may perform the SLAM by using positional data from the positional sensor(s) 236.

According to various implementations, the display driver 250 obtains metadata associated with the one or more widgets 246 in order to drive display of the one or more widgets 246 as display-locked, body-locked, or world-locked. The metadata may be generated by a developer who developed the widget. As one example, the metadata indicates a display position value (e.g., center of the display), and the display driver 250 displays a corresponding display-locked widget on the display 260 according to the display position value. As another example, for a body-locked widget, the metadata indicates a distance value with respect to a portion of a body of a user, and an angular value with respect to the portion of the body. For example, the distance value corresponds to one meter in front of the torso of the user, and the angular value corresponds to 45 degrees left of the center of the torso of the user.

According to various implementations, the system 200 defines the metadata. In some implementations, a user input specifies a particular display mode (e.g., display-locked, body-locked, or world-locked) for a particular widget. In some implementations, the metadata includes one or more of a use case indicator value or a context indicator value. For example, the use case indicator value indicates a furniture shopping use case. Accordingly, the system 200 sets a tape measurement widget as display-locked. By displaying the tape measurement widget as display-locked, the system 200 maintains display of the tape measurement widget, even as a user moves through different rooms of a building while evaluating the placement of virtual furniture within the rooms.

When the display driver 250 receives a plurality of widgets, the display driver 250 may selectively drive the display 260 based on a display priority value 254. In some implementations, the display priority value 254 is a function of a combination of plurality semantic values respectively associated with the plurality of widgets. For example, the display driver 250 receives an oven temperature widget associated with an “oven” and receives a scorekeeping widget associated with a “ping pong table.” Continuing with this example, the display driver 250 drives the display 260 with the temperature widget but not with the scorekeeping widget, because temperature information is associated with a time-sensitive activity, whereas scorekeeping information is associated with a recreational activity and thus is associated with a lower display priority.

FIGS. 3A-3P are examples of displaying contextualized widgets in accordance with some implementations. As illustrated in FIG. 3A, a left hand of a user 50 is holding an electronic device 310. In some implementations, the electronic device 310 generates one of the XR settings described above. The electronic device 310 is associated with (e.g., included in) a physical environment 300. The physical environment 300 includes a first wall 301 and a second wall 302. Moreover, the physical environment 300 includes a physical counter 303 against the first wall 301, and a physical refrigerator 304 against the first wall 301. Additionally, the physical environment 300 includes a physical frying pan 306 resting on the physical counter 303, and a physical oven 308 resting on the physical counter 303. The electronic device 310 includes a display 312 (e.g., the display 260 in FIG. 2) that is associated with a first viewable region 314 of the physical environment 300. In some implementations, the electronic device 310 is similar to and adapted from the electronic device 100 in FIG. 1. In some implementations, the electronic device 310 includes a system, such as the system 210 in FIG. 2.

In some implementations, the electronic device 310 corresponds to a head-mountable device (HMD) that includes an integrated display (e.g., a built-in display) that displays a representation of the physical environment 300. In some implementations, the electronic device 310 includes a head-mountable enclosure. In various implementations, the head-mountable enclosure includes an attachment region to which another device with a display can be attached. In various implementations, the head-mountable enclosure is shaped to form a receptacle for receiving another device that includes a display (e.g., the electronic device 310). For example, in some implementations, the electronic device 310 slides/snaps into or otherwise attaches to the head-mountable enclosure. In some implementations, the display of the device attached to the head-mountable enclosure presents (e.g., displays) the representation of the physical environment 300. For example, in some implementations, the electronic device 310 corresponds to a mobile phone that can be attached to the head-mountable enclosure.

In some implementations, the electronic device 310 includes an image sensor, such as a scene camera. For example, the image sensor obtains image data that characterizes the physical environment 300, and the electronic device 310 composites the image data with computer-generated content in order to generate display data for display on the display 312. The display data may be characterized by an XR environment. For example, the image sensor obtains image data that represents a portion of the physical environment 300, and the generated display data includes the representation of the portion of the physical environment 300 (See FIG. 3D).

In some implementations, the electronic device 310 includes a see-through display. The see-through display permits ambient light from the physical environment through the see-through display, and the representation of the physical environment is a function of the ambient light. For example, the see-through display is a translucent display, such as glasses with optical see-through. In some implementations, the see-through display is an additive display that enables optical see-through of the physical surface, such as an optical HMD (OHMD). For example, unlike purely compositing using a video stream, the additive display is capable of reflecting projected images off of the display while enabling the user to see through the display. In some implementations, the see-through display includes a photochromic lens. The HMD adds computer-generated objects to the ambient light entering the see-through display in order to enable display of the physical environment 300. For example, a see-through display permits ambient light from the physical environment 300, and thus the see-through display presents a representation of a portion of the physical environment 300. (See FIG. 3D).

As illustrated in FIG. 3B, the electronic device 310 semantically identifies, via the object identifier 220, the physical refrigerator 304, the physical frying pan 306, and the physical oven 308. For example, the object identifier 220 performs semantic segmentation with respect to image data representing the physical refrigerator 304, the physical frying pan 306, and the physical oven 308. Semantic identification of the physical refrigerator 304 is indicated by a first tracking line 316a and a first bounding box 316b that bounds the physical refrigerator 304. Semantic identification of the physical frying pan 306 is indicated by a second tracking line 318a and a second bounding box 318b that bounds the physical frying pan 306. Semantic identification of the physical oven 308 is indicated by a third tracking line 320a and a third bounding box 320b that bounds the physical oven 308. In particular, the object identifier 220 determines a first semantic value 316c of “Refrigerator” associated with the physical refrigerator 304, a second semantic value 318c of “Frying Pan” associated with the physical frying pan 306, and a third semantic value 318c of “Oven” associated with the physical oven 308. Although the examples in FIGS. 3A-3P illustrate semantic identification of multiple physical objects, one of ordinary skill in the art will appreciate that, in some implementations, semantic identification and widget selection based on the semantic identification proceeds with respect to a single physical object.

As illustrated in FIG. 3C, based on the semantic values (“Refrigerator” 316c, “Frying Pan” 318c, and “Oven” 320c) from the object identifier 220, the widget selector 240 selects and obtains corresponding widgets. For example, the widget selector 240 obtains, from the widget datastore 242, a grocery list widget 322 based on the first semantic value 316c of “Refrigerator,” a timer widget 324 based on the second semantic value 318c of “Frying Pan,” and an oven status widget 326 based on the third semantic value 320c of “Oven.” In some implementations, the widget selector 240 utilizes metadata associated with a widget in order to select the widget. As one example, the widget selector 240 obtains metadata associated with the grocery list widget 322, wherein the metadata indicates that the grocery list widget 322 is suitable for physical containers commonly found in a kitchen, such as a refrigerator, kitchen pantry, etc. As another example, the widget selector 240 obtains metadata associated with the timer widget 324, wherein the metadata indicates that the timer widget 324 is suitable for a cookware object or a bakeware object, such as a frying pan. In some implementations, the widget selector 240 selects a particular widget based on text matching. As one example, the widget selector 240 selects the oven status widget 326 because the respective names of the oven status widget 326 and the third sematic value 320c of “Oven” both include the word “oven.”

In some implementations, the widget selector 240 selects a particular widget based on a combination of the semantic value and the widget criterion 244. For example, the widget criterion 244 may be a function of a user profile, current or historical user activity, popular (e.g., trending) widgets, etc. As one example, the user profile indicates a user’s hobbies include cooking, and thus the widget selector 240 selects the timer widget 324 in order to enable the display of timer information while the user is cooking. As another example, in response to obtaining an indication that a particular augmented reality (AR) game is trending, the widget selector 240 selects the particular AR game when the semantic value indicates a type of physical object that is used during gameplay (e.g., the gameplay includes throwing virtual balls onto the surface of a physical table).

In some implementations, the widget selector 240 selects a particular widget based on a combination of the semantic value and an engagement score that is associated with the particular widget. The engagement score characterizes a level of user engagement with respect to the particular widget. For example, the engagement score is output from the engagement score generator 222 illustrated in FIG. 2. In some implementations, the widget selector 240 selects a particular widget associated with a corresponding physical object in response to determining that a corresponding engagement score exceeds a threshold value. For example, with reference to FIGS. 2 and 3C, based on eye tracking data indicating an eye gaze of the user 50 is focused on the physical refrigerator 304, the engagement score generator 222 determines a corresponding engagement score of 0.9 for the physical refrigerator 304. Because the corresponding engagement score of 0.9 is above a threshold value of 0.5, the widget selector 240 selects and retrieves the grocery list widget 322. As a counterexample, based on the eye tracking data, the engagement score generator 222 determines a corresponding engagement score of 0.0 for the physical oven 308 because the eye gaze is not focused on the physical oven 308. Because the corresponding engagement score of 0.0 is not above the threshold value of 0.5, the widget selector 240 foregoes selecting and retrieving the oven status widget 326. Accordingly, by selectively retrieving widgets, the widget selector 240 utilizes fewer memory and processing resources.

As further illustrated in FIG. 3C, based on selected widgets from the widget selector 240, the display driver 250 drives the display 312 or a display 362. The display 362 is integrated in an HMD 360, which is described with reference to FIGS. 3H-3P. The display driver 250 drives the display 312/362 based on the object-proximity criterion 252. In some implementations, the object-proximity criterion 252 is based on metadata associated with a corresponding widget. For example, the display driver 250 obtains metadata associated with the grocery list widget 322, wherein the metadata indicates that the grocery list widget 322 is suitable to display as world-locked to a food container, such as a refrigerator. Accordingly, the display driver 250 drives display of the grocery list widget 322 as a world-locked grocery list widget 330. For example, with reference to FIG. 2, the object identifier 220 performs a combination of SLAM and semantic segmentation in order to determine a 3D anchor corresponding to a point on the physical refrigerator 304. Continuing with this example, the display driver 250 displays the world-locked grocery list widget 330 as world-locked to the 3D anchor.

As another example, the display driver 250 obtains metadata associated with the timer widget 324, wherein the metadata indicates that the timer widget 324 is suitable to display as body locked. Accordingly, the display driver 250 drives display of the timer widget 324 as a body-locked timer widget 332. As yet another example, the display driver 250 obtains metadata associated with the oven status widget 326, wherein the metadata indicates that the oven status widget 326 is suitable to display as head locked. Accordingly, the display driver 250 drives display of the oven status widget 326 as a head-locked oven status widget 334.

As illustrated in FIG. 3D, the electronic device 310 displays, on the display 312, the world-locked grocery list widget 330 and the head-locked oven status widget 334. The body-locked timer widget 332 is not initially displayed because, as will be described below, a particular pose change of the HMD 360 may trigger display of the body-locked timer widget 332.

The world-locked grocery list widget 330 is locked to the physical refrigerator 304. The world-locked grocery list widget 330 includes a list of grocery items and various affordances for modifying and sharing the list of grocery items, as will be described below.

According to various implementations, the display driver 250 drives display of the world-locked grocery list widget 330 as locked to the physical refrigerator 304 based on a function of pose data from the positional sensor(s) 236. For example, based on IMU and/or image data indicating a slight leftwards rotation of the electronic device 310 towards the second wall 302, the display driver 250 correspondingly moves the world-locked grocery list widget 330 to the right on the display 312 such that the world-locked grocery list widget 330 appears stationary relative to the physical refrigerator 304. As illustrated in FIG. 3D, the world-locked grocery list widget 330 is locked at a first distance from the upper-left corner of the physical refrigerator 304. The upper-left corner of the physical refrigerator 304 is indicated by a first reticle 340 (illustrated for purely explanatory purposes). Moreover, the first distance is indicated by a first distance line 342 (illustrated for purely explanatory purposes). The display driver 250 maintains display of the world-locked grocery list widget 330 as locked at the first distance from the upper-left corner of the physical refrigerator 304 in order to satisfy the object-proximity criterion 252 with respect to the physical refrigerator 304.

In some implementations, the display 312 includes the world-locked grocery list widget 330 so long as a viewable region associated with the display 312 includes a portion of the physical environment 300 that includes the physical refrigerator 304. As a counterexample, as illustrated in FIGS. 3I and 3J, a third viewable region 372 associated with the display 362 does not include the physical refrigerator 304, and thus the display 362 ceases to include the world-locked grocery list widget 330.

On the other hand, the head-locked oven status widget 334 is locked to a particular region of the display 312. Namely, the head-locked oven status widget 334 is locked near the upper-right corner of the display 312. The head-locked oven status widget 334 is locked at a first horizontal distance 344a (illustrated for purely explanatory purposes) from the left edge of the display 312, at a second horizontal distance 344b (illustrated for purely explanatory purposes) from the right edge of the display 312, and at a vertical distance 346 (illustrated for purely explanatory purposes) from the top edge of the display 312. The head-locked oven status widget 334 include status indicators associated with the physical oven 308, such as cooking status and temperature. For example, as illustrated in FIGS. 3D-3P, the temperature associated with the physical oven 308 changes as the current time changes. To that end, in some implementations, the physical oven 308 is a smart oven, and the electronic device 310 receives some or all of the status indicators from the physical oven 308, such as via Bluetooth or Wi-Fi.

FIGS. 3E-3G illustrate examples of interacting with a widget that includes one or more affordances, based on a series of user inputs. The user inputs may correspond to a combination of eye tracking data (e.g., from the eye tracker 234) and extremity tracking data (e.g., from the extremity tracker 232). The eye tracking data may indicate an eye gaze position or an eye focus position associated with the user 50. The extremity tracking data may an indicate a position or movement of an extremity of the user 50, wherein the extremity is within a current viewable region associated with the display 312.

As illustrated in FIG. 3E, the electronic device 310 receives a first user input 348 that selects (e.g., is directed to) an add item affordance within the world-locked grocery list widget 330. In response to receiving the first user input 348 in FIG. 3E, the electronic device 310 changes the world-locked grocery list widget 330 to include a submenu for adding items to the grocery list, as illustrated in FIG. 3F. In some implementations, based on determining that the first user input 348 is directed to the world-locked grocery list widget 330, the electronic device 310 updates one or more engagement scores. For example, the electronic device 310 reduces an engagement score associated with the physical oven 308 because the first user input 348 is directed to a portion of an environment that is relatively far from the physical oven 308. In some implementations, in response to determining that the engagement score associated with the physical oven 308 falls below a threshold value, the electronic device 310 ceases to display the head-locked oven status widget 334. For example, in response to detecting a threshold number of inputs directed to the world-locked grocery list widget 330 or detecting engagement with the world-locked grocery list widget 330 for more than a threshold amount of time, the electronic device 310 ceases to display the head-locked oven status widget 334.

As further illustrated in FIG. 3F, the electronic device 310 receives a second user input 350 that selects (e.g., is directed to) an add eggs affordance, which triggers the electronic device 310 to add “Eggs” to the grocery list, as illustrated in FIG. 3G. One of ordinary skill in the art will appreciate that, in some implementations, the electronic device 310 facilitates user-input driven interaction with a widget associated with a different display-locked criterion, such as a body-locked widget or a head-locked widget.

FIGS. 3H-3P illustrate an example of displaying the body-locked timer widget 332. As illustrated in the FIG. 3H, the user 50 is wearing an HMD 360 that includes a display 362. In some implementations, the HMD 360 generates one of the XR settings described above. In some implementations, the HMD 360 includes the system 210 or a portion thereof. The display 362 is associated with a second viewable region 364. The second viewable region 364 includes the physical refrigerator 304, the physical frying pan 306, and the physical oven 308. Moreover, a second reticle 366 over the right shoulder of the user 50 is illustrated in order to indicate that the body-locked timer widget 332 is locked to the right shoulder of the user 50. One of ordinary skill in the art will appreciate that, in some implementations, the body-locked timer widget 332 is locked to a different portion of the body of the user 50.

As illustrated in FIGS. 3H and 3I, the HMD 360 moves towards the first wall 301 and turns rightwards and downwards towards the physical frying pan 306, as is indicated by movement line 370 in FIG. 3H. Accordingly, the display 362 changes from being associated with the second viewable region 364 to a third viewable region 372, as illustrated in FIG. 3I. In contrast to the second viewable region 364, the third viewable region 372 does not include the physical refrigerator 304 or the physical oven 308. Moreover, the third viewable region 372 is characterized by a downward tilt towards the physical frying pan 306. Accordingly, as illustrated in FIG. 3J, the display 362 includes an egg cooking on a cookware surface of the physical frying pan 306, but does not include the physical refrigerator 304 or the physical oven 308.

In some implementations, in response to identifying the cookware surface of the physical frying pan 306, the HMD 360 displays, on the display 362, a widget indicator associated with the body-locked timer widget 332. For example, as illustrated in FIG. 3J, the widget indicator includes a widget name indicator 373a (“Timer Widget”) and a widget arrow indicator 373b. The direction of the widget arrow indicator 373b indicates to the user 50 that a positional change of the HMD 360 toward the right shoulder of the user 50 triggers display of the body-locked timer widget 332.

Additionally, the display 362 includes the head-locked oven status widget 334 because the third viewable region 372 satisfies a proximity threshold with respect to the physical oven 308, even though the physical oven 308 is not within the third viewable region 372. For example, the third viewable region 372 is less than a threshold distance from the physical oven 308 within the physical environment 300. Notably, the HMD 360 displays the head-locked oven status widget 334 locked at the first horizontal distance 344a from the left edge of the display 362, at the second horizontal distance 344b from the right edge of the display 362, and at the vertical distance 346 from the top edge of the display 362.

As illustrated in FIG. 3K, the HMD 360 rotates towards the right shoulder of the user 50 (e.g., towards the second reticle 366), as indicated by a first rotational indicator 374. For example, positional sensor(s) 236 (e.g., an IMU or camera) integrated in the HMD 360 detect the rotational movement. In response to the rotation of the HMD 360 in FIG. 3K, the HMD 360 faces away from the first wall 301, as illustrated in FIG. 3L. Accordingly, the display 362 changes from being associated with the third viewable region 372 to a fourth viewable region 376.

Based on the rotation of the HMD 360 towards the right shoulder of the user 50, the display 362 ceases to include the physical frying pan 306, as illustrated in FIG. 3M. However, the display 362 continues to include the head-locked oven status widget 334. Moreover, the display 362 includes the body-locked timer widget 332 based on the rotation of the HMD 360 towards the right shoulder of the user 50. Accordingly, while the cookware surface of the physical frying pan 306 is within a viewable region of the display, a movement of the HMD towards a particular portion of the body of the user 50 (e.g., towards the right shoulder) triggers display of the body-locked timer widget 332. The body-locked timer widget 332 includes an indication of time remaining and includes one or more affordances for interacting with the body-locked timer widget 332. By not persistently displaying the body-locked timer widget 332, the HMD 360 avoids displaying an excessive number of widgets that may clutter the display 362. Moreover, displaying the body-locked timer widget 332 in response to detecting a particular (e.g., predetermined) movement of the HMD 360 enables the user 50 to seamlessly control display of the body-locked timer widget 332, such as when the user 50 wants a time check regarding the cooking of the egg. For example, the user 50 need not press a physical button on the HMD 360 or engage eye tracking or extremity tracking in order to trigger display of the body-locked timer widget 332, thereby improving the user experience.

As illustrated in FIG. 3N, the HMD 360 rotates away from the right shoulder of the user 50 (e.g., away from the second reticle 366) towards the first wall 301, as indicated by a second rotational indicator 378. Accordingly, the display 362 changes from being associated with the fourth viewable region 376 to a fifth viewable region 380, as illustrated in FIG. 3O. The fifth viewable region 380 includes the physical frying pan 306. Based on the rotation away from the right shoulder of the user 50, the HMD 360 ceases to display the body-locked timer widget 332, as illustrated in FIG. 3P. However, the display 362 continues to include the head-locked oven status widget 334 and the widget indicator.

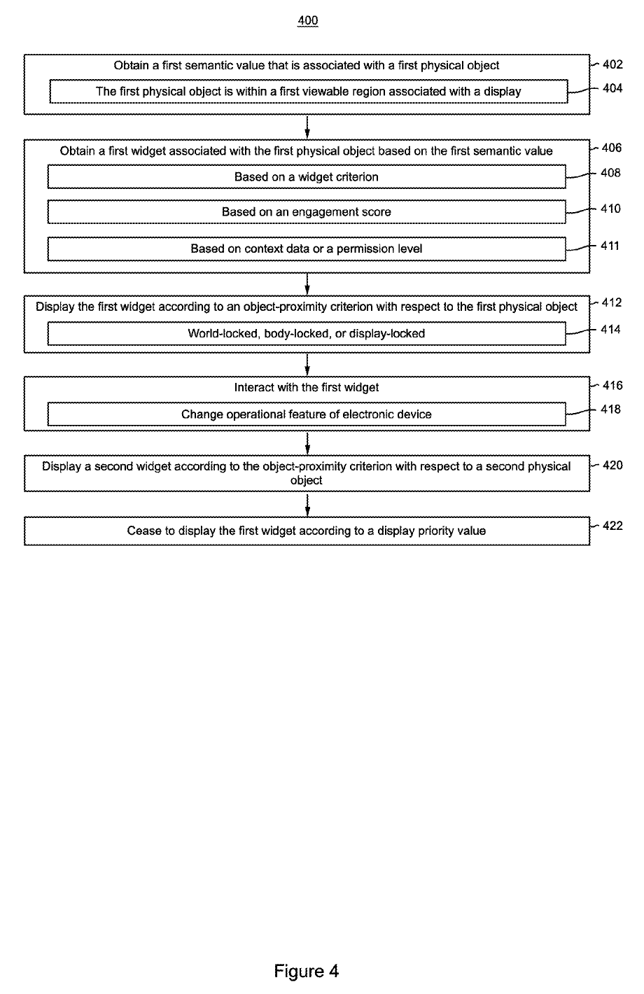

FIG. 4 is an example of a flow diagram of a method 400 of displaying one or more contextualized widgets in accordance with some implementations. In various implementations, the method 400 or portions thereof is performed by an electronic device including a display (e.g., the electronic device 100 in FIG. 1 or the electronic device 310 in FIGS. 3A-3G). In various implementations, the method 400 or portions thereof is performed by the system 210 illustrated in FIG. 2. In various implementations, the method 400 or portions thereof is performed by a head-mountable device (HMD), such as the HMD 360 described with reference to FIGS. 3H-3P. In some implementations, the method 400 is performed by processing logic, including hardware, firmware, software, or a combination thereof. In some implementations, the method 400 is performed by a processor executing code stored in a non-transitory computer-readable medium (e.g., a memory). In various implementations, some operations in method 400 are, optionally, combined and/or the order of some operations is, optionally, changed.

As represented by block 402, the method 400 includes obtaining a first semantic value that is associated with a first physical object. As represented by block 404, the first physical object is within a first viewable region associated with a display. For example, with reference to FIG. 3B, the electronic device 310 obtains, via the object identifier 220, a first semantic value 316c associated with the physical refrigerator 304. In some implementations, the method 400 includes utilizing a computer-vision technique in order to determine the first semantic value.

As represented by block 406, the method 400 includes obtaining a first widget that is associated with the first physical object, based on the first semantic value. For example, obtaining the first widget includes performing text-based matching and/or metadata-based matching with respect to the first widget. As one example, with reference to FIG. 3C, the widget selector 240 selects a grocery list widget 322 based on the first semantic value 316c of “Refrigerator.” To that end, the widget selector 240 may select the grocery list widget 322 based on corresponding metadata indicating that the grocery list widget 322 is suitable for use with a food container. In some implementations, the first widget includes a status indicator that is based on the first semantic value. For example, with reference to FIGS. 3A-3D, the head-locked oven status widget 334 includes an indication of the current temperature of the physical oven 308.

As represented by block 408, in some implementations, obtaining the first widget is further based on a function of a widget criterion. For example, the widget criterion is based on a user profile, time of day, current or historical user activity, popular widgets, etc. As one example, with referenced to FIG. 3C, the widget selector 240 selects the timer widget 324 based in part on a user profile indicating that a user lists cooking as a hobby. As another example, the method 400 includes selecting a football scoreboard widget on Sunday during football season.

As represented by block 410, in some implementations, obtaining the first widget is in response to determining that an engagement score satisfies an engagement threshold. To that end, the method 400 includes determining the engagement score, which characterizes a level of user engagement with respect to the first physical object. The engagement score may be a function of eye tracking data associated with a user and/or extremity tracking data associated with the user. For example, with reference to FIG. 2 and FIG. 3C, the engagement score generator 222 determines, based on eye tracking data, that an eye gaze of the user is focused on the physical refrigerator 304 for more than a threshold amount of time. Accordingly, the engagement score generator 222 determines and outputs a first engagement score of 0.9, which is associated with the physical refrigerator 304. Continuing with this example, based on the engagement score of 0.9, the widget selector 240 obtains a grocery list widget 332 because the first engagement score of 0.9 exceeds a threshold engagement value of 0.5.

As represented by block 411, in some implementations, obtaining the first widget is further based on context data and/or based on a permission level associated with a user of an electronic device performing the method 400. For example and with reference to FIG. 2, the widget selector 240 uses the context data 227 from the context engine 226 in order to select the first widget. Examples of the context data are scene type (e.g., indoors versus outdoors, room type), amount of time spent in a particular scene, amount of movement and recency of the movement, etc. As another example and with continued reference to FIG. 2, the widget selector 240 uses the permission level 229 from the permission engine 228 in order to select the first widget. For example, the permission level 229 is higher for an adult than for a child, and thus the widget selector 240 selects a game widget for the adult, and selects an educational widget for the child.

As represented by block 412, the method 400 includes displaying, on the display, the first widget according to an object-proximity criterion with respect to the first physical object. For example, the object-proximity criterion is satisfied when the first widget is within a current viewable region associated with the display. As another example, when the current viewable region does not include the first physical object, the object-proximity criterion is satisfied when the first physical object is less than a threshold distance from the current viewable region within a physical environment. To that end, in some implementations, an electronic device identifies a physical surface that is proximate to the first physical object (e.g., the physical counter 303 is proximate to the physical refrigerator 304), and determines that the object-proximity criterion is satisfied when the physical surface is within the current viewable region.

In some implementations, as represented by block 414, displaying the first widget according to the object-proximity criterion includes displaying the first widget as world-locked, body-locked, or display-locked. For example, with reference to FIG. 3D, the electronic device 310 displays, on the display 312, the world-locked grocery list widget 330 and the head-locked oven status widget 334. As another example, with reference to FIG. 3M, the HMD 360 displays, on the display 362, the body-locked timer widget 332.

As represented by block 416, in some implementations, the method 400 includes enabling an interaction with the first widget. To that end, in some implementations, the method 400 includes detecting, via an input device, a user input associated with an affordance that is within the first widget, and in response to detecting the user input, performing a respective operation associated with the affordance. For example, the respective operation includes navigating through sub-menus of the first widget. As one example, the electronic device 310 navigates to a submenu of the world-locked grocery list widget 330 based on the first user input 348, as illustrated in FIGS. 3E and 3F. As another example, the respective operation includes modifying content displayed within the first widget, such as the electronic device 310 adding “Eggs” to the grocery list based on the second user input 350 illustrated in FIGS. 3F and 3G. As yet another example, the respective operation includes moving or resizing the first widget, or merging the first widget with a second widget.

As represented by block 418, in some implementations, the affordance corresponds to a control affordance, and performing the respective operation corresponds to changing an operational feature associated with the electronic device. For example, when the first semantic value is a “screw head” or “screw drive,” the first widget includes a flashlight affordance. Continuing with this example, selection of the flashlight affordance triggers illumination of a flashlight integrated in an electronic device, in order to aid a user in rotating the screw. As another example, when the first semantic value is “pillow,” the first widget includes a do not disturb affordance, which, when selected, places an electronic device into a do not disturb mode of operation.

As represented by block 420, in some implementations, the method 400 includes displaying a second widget according to the object-proximity criterion with respect to a second physical object. To that end, in some implementations, the method 400 includes obtaining a second semantic value that is associated with the second physical object, which is within the first viewable region associated with the display. Moreover, the method 400 includes obtaining the second widget based on the second semantic value. For example, with reference to FIG. 3E, the display 312 includes the world-locked grocery list widget 330 and the head-locked oven status widget 334.

As represented by block 422, in some implementations, the method 400 includes while displaying the second widget, ceasing to display the first widget according to a display priority value. For example, the display priority value is based on a user preference or popularity of certain widgets (e.g., trending widgets).

In some implementations, the display priority value is based on a combination of the first and second semantic values. For example, the second semantic value is “oven,” which may be associated with priority information (e.g., temperature of the oven), whereas the first semantic value is “ping pong table.” Accordingly, an electronic device ceases to display a widget associated with the ping pong table, and maintains display of a widget associated with the oven in order to continue to provide priority information to a user.

In some implementations, the display priority value is based on a first position associated with the first physical object and a second position associated with the second physical object. For example, the first position is further in a scene background than the second position, and thus the method 400 includes ceasing to display the first widget.

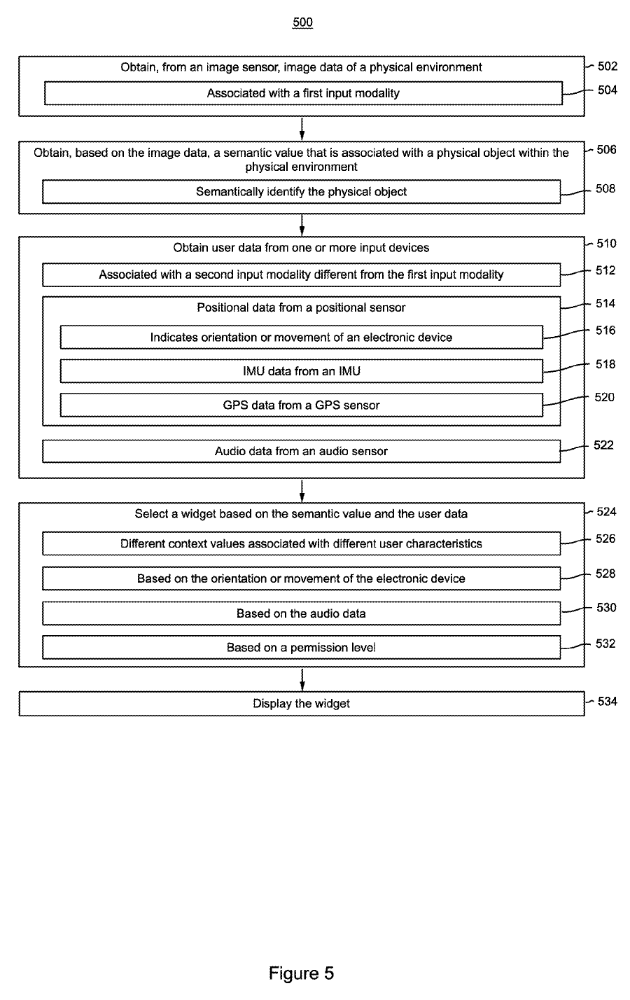

FIG. 5 is an example of a flow diagram of a method 500 of displaying a contextualized widget based on different input modalities in accordance with some implementations. In various implementations, the method 500 or portions thereof is performed by an electronic device including an image sensor, one or more input devices, and a display. In various implementations, the method 500 or portions thereof is performed by the system 210 illustrated in FIG. 2. In various implementations, the method 500 or portions thereof is performed by a head-mountable device (HMD), such as the HMD 360 described with reference to FIGS. 3H-3P. In some implementations, the method 500 is performed by processing logic, including hardware, firmware, software, or a combination thereof. In some implementations, the method 500 is performed by a processor executing code stored in a non-transitory computer-readable medium (e.g., a memory). In various implementations, some operations in method 500 are, optionally, combined and/or the order of some operations is, optionally, changed.

As represented by block 502, the method 500 includes obtaining, from an image sensor, image data of a physical environment. As represented by block 504, the image data is associated with a first input modality. For example, with reference to FIGS. 2 and 3A, the image sensor 212 obtains the image data 214 of the physical environment 300. As one example, the image sensor is a rear-facing camera of a smartphone that is pointed towards the physical environment 300, wherein the rear-facing camera has a field-of-view that approximates the viewable region 314 of the display 312.

As represented by block 506, the method 500 includes obtaining, based on the image data, a semantic value that is associated with a physical object within the physical environment. For example, with reference to FIGS. 2 and 3B, the object identifier 220 determines various semantic values, such as the first semantic value 316c of “Refrigerator” associated with the physical refrigerator 304. To that end, in some implementations, as represented by block 508, the method 500 includes determining the semantic value by semantically identifying the physical object within the image data. For example, the method 500 includes performing per-pixel semantic segmentation with respect to the image data, optionally with the aid of a neural network.

As represented by block 510, the method 500 includes obtaining user data from one or more input devices. As represented by block 512, the user data is associated with a second input modality that is different from the first input modality. For example, the one or more input devices obtain the user data independently of an image sensor. As another example, the user data does not include image data.

For example, as represented by block 514, the user data includes positional data from a positional sensor, such as the positional sensor(s) 236 described with reference to FIG. 2. As represented by block 516, the positional data may indicate an orientation of an electronic device or a movement of the electronic device. As one example, with reference to FIGS. 3H and 3I, the HMD 360 includes a positional sensor that generates positional data indicating a translational movement of the HMD 360 towards the first wall 301. As another example, with reference to FIGS. 3K and 3L, the HMD 360 includes a positional sensor that generates positional data indicating a rotational movement of the HMD 360 towards the right shoulder of the user 50. Continuing with the previous example, with reference to FIG. 3L, after completion of the rotational movement, the positional sensor generates positional data indicating that the orientation of the HMD 360 is approximately 90 degrees offset from the orientation of the HMD 360 before the rotational movement. In some implementations, as represented by block 518, the positional data includes inertial measurement unit (IMU) data from an IMU. In some implementations, as represented by block 520, the positional data includes global position system (GPS) data from a GPS. Whereas the IMU data may indicate orientation information and smaller scale movement information (e.g., walking across a room), the GPU data may indicate larger scale movement information. For example, the GPU data may indicate a speed value, such as miles per hour or kilometers per hour.

As another example, as represented by block 522, the user data includes audio data from an audio sensor, such as the audio sensor 238 illustrated in FIG. 2. The audio sensor may correspond to a microphone that detects ambient sound in a physical environment. For example, the audio sensor generates audio data including speech of a user or other bodily sounds produced by the user, such as sneezing, chewing, coughing, etc.

As represented by block 524, the method 500 includes selecting a widget based on the semantic value and the user data. For example, with reference to FIG. 2, the user data corresponds to the context data 227, and the widget selector 240 selects the widget(s) 246 based on the semantic value(s) 224 and the context data 227.

As represented by block 526, in some implementations, selecting the widget is based on different context values indicated within the user data. For example, with reference to FIG. 2, the widget selector 240 obtains the context data 227, which indicates a first context value and a second context value. In some implementations, the context data 227 indicates the first context value at a first point in time, and the context data 227 indicates the second context value at a second point in time. As one example, the first context value indicates a nominal speed value (e.g., approximately zero miles per hour) associated with the system 210, wherein the second context value indicates a speed value higher than a threshold (e.g., more than five miles per hour) associated with the system 210. Continuing with this example, based on a sematic value of “car speedometer,” the widget selector 240 foregoes selecting a widget for the second context value for convenience reasons, because a user of the system 210 may be driving a car. On other hand, for the first context value and the sematic value of “car speedometer,” the widget selector 240 determines that the user is sitting inside the car but not currently driving, and thus may select a grocery list widget in order to remind the user which items to purchase. The speed values associated with the system 210 may be generated by a GPS sensor integrated in the system 210.

As represented by block 528, in some implementations, selecting the widget is based on the orientation of the electronic device or the movement of the electronic device.

For example, when the semantic value is “dumbbell,” and the orientation corresponds to a substantial downward tilt of the electronic device, the method 500 determines that the user is likely looking at a dumbbell on the ground and thus selects a fitness widget to aid the user in a fitness routine with the dumbbell. As a counterexample, when the semantic value is “dumbbell,” but the orientation does not correspond to the substantial downward tilt (e.g., neutral tilt or upward tilt), the method 500 determines that the dumbbell is not currently being used as part of a fitness routine. For example, the user is shopping for a dumbbell online or at a sporting goods store. Accordingly, the method 500 includes foregoing selecting the fitness widget.

As another example, the semantic value is “bicycle helmet,” and the movement of the electronic device is above a threshold speed (e.g., based on GPU data). Accordingly, the method 500 determines that the user is likely riding a bicycle abreast of another bicyclist and accordingly selects a bicycle riding widget or a walkie-talkie widget.

As yet another example, with reference to FIGS. 3N and 3O, based on IMU data indicating a rotational movement of the HMD 360, and based on the semantic value of “frying pan,” the method 500 includes selecting the timer widget 373a.

An additional example of using a movement of the electronic device to select a widget is described with reference to block 526.

As represented by block 530, in some implementations, selecting the widget is based on the audio data. For example, when the semantic value is “cold medicine,” and the audio data corresponds to a sneeze or cough, the method 500 includes selecting a web browser widget including search results for treating a cold. Continuing with the previous example, the method 500 may include additionally or alternatively selecting a phone calling widget with the phone number of the user’s doctor ready to be dialed. As another example, when the semantic value(s) are “plate” and/or “plate of food,” and the audio data corresponds to a chewing sound, the method 500 includes selecting a diet widget that tracks what a user has eaten that day. In some implementations, selecting the widget based on the audio data includes determining that the audio data satisfies an audio pattern criterion. For example, the audio pattern criterion is based on different versions of predetermined sounds, such as different coughing sounds, different chewing sounds, different sneezing sounds, etc. Thus, when the audio data matches a particular predetermined sound within an error threshold, the method 500 determines that the audio pattern criterion is satisfied.

As represented by block 532, in some implementations, selecting the widget is further based on permission level, such as described with reference block 411 of FIG. 4. In some implementations, the permission level is determined by a permission engine, such as the permission engine 228 described with reference to FIG. 2. As one example, a first user of a first electronic device is engaged in a copresence session with a second user of a second electronic device. Continuing with this example, the first and second electronic devices are pointed at an open refrigerator, and thus each of the first and second electronic devices obtains the semantic value of “Refrigerator.” Additionally, each of the first and second electronic devices obtains, via a respective audio sensor, audio data corresponding to speech of “you are out of eggs.” However, because the first user has a higher permission level with respect to the refrigerator (e.g., the refrigerator belongs to the first user), the first electronic device selects a grocery list widget to enable the first user to add eggs, whereas the second electronic device foregoes selecting the grocery list widget.

As represented by block 534, the method 500 includes displaying the widget. In some implementations, the widget is displayed as world-locked to the physical object, such as described with reference to block 414 of FIG. 4.

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be implemented in such program instructions, although some or all of the disclosed functions may alternatively be implemented in application-specific circuitry (e.g., ASICs or FPGAs or GP-GPUs) of the computer system. Where the computer system includes multiple computing devices, these devices may be co-located or not co-located. The results of the disclosed methods and tasks may be persistently stored by transforming physical storage devices, such as solid-state memory chips and/or magnetic disks, into a different state.

Various processes defined herein consider the option of obtaining and utilizing a user’s personal information. For example, such personal information may be utilized in order to provide an improved privacy screen on an electronic device. However, to the extent such personal information is collected, such information should be obtained with the user’s informed consent. As described herein, the user should have knowledge of and control over the use of their personal information.

Personal information will be utilized by appropriate parties only for legitimate and reasonable purposes. Those parties utilizing such information will adhere to privacy policies and practices that are at least in accordance with appropriate laws and regulations. In addition, such policies are to be well-established, user-accessible, and recognized as in compliance with or above governmental/industry standards. Moreover, these parties will not distribute, sell, or otherwise share such information outside of any reasonable and legitimate purposes.

Users may, however, limit the degree to which such parties may access or otherwise obtain personal information. For instance, settings or other preferences may be adjusted such that users can decide whether their personal information can be accessed by various entities. Furthermore, while some features defined herein are described in the context of using personal information, various aspects of these features can be implemented without the need to use such information. As an example, if user preferences, account names, and/or location history are gathered, this information can be obscured or otherwise generalized such that the information does not identify the respective user.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems, and are not limited to the methods and systems described above, and elements and acts of the various implementations described above can be combined to provide further implementations. Accordingly, the novel methods and systems described herein may be implemented in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A method comprising:
at a device including a non-transitory memory, one or more processors, and a display:
obtaining a semantic value that is associated with a physical object within a physical environment of the device;
selecting a widget based on the semantic value;
obtaining position data that characterizes a current pose or pose change of the device;
in accordance with a determination that the position data satisfies position criteria, displaying the widget on the display; and
in accordance with a determination that the position data does not satisfy the position criteria, forgoing display of the widget.

2. The method of claim 1, wherein obtaining the semantic value includes:
capturing, using an image sensor, an image of the physical environment; and
semantically identifying the physical object within the image data.

3. The method of claim 1, wherein the position data includes an inertial measurement unit (IMU) data from an IMU.

4. The method of claim 1, wherein the position data includes global positioning system (GPS) data from a GPS sensor.

5. The method of claim 1, wherein the position data indicates a speed of the device and the position data satisfies the position criteria when the speed of the device satisfies a speed criterion.

6. The method of claim 5, wherein the speed of the device satisfies the speed criterion when the speed of the device is above a speed threshold.

7. The method of claim 5, wherein the speed of the device satisfies the speed criterion when the speed of the device is below a speed threshold.

8. The method of claim 1, wherein the position data indicates an orientation of the device and the position data satisfies the position criteria when the orientation of the device satisfies an orientation criterion.

9. The method of claim 1, wherein the position data indicates a rotational movement of the device and the position data satisfies the position criteria when the rotational movement of the device satisfies a rotational criterion.

10. The method of claim 1, further comprising:
determining, based on the widget, the position criteria; and
determining whether the position data satisfies the position criteria.

11. The method of claim 1, wherein displaying the widget includes displaying the widget world-locked to the physical object.

12. The method of claim 1, wherein forgoing display of the widget includes displaying no widget.

13. The method of claim 1, wherein forgoing display of the widget includes:
selecting an alternate widget based on the semantic value; and
displaying the alternate widget.

14. A device comprising:
a display;
non-transitory memory;
one or more processors to:
obtain a semantic value that is associated with a physical object within a physical environment of the device;
select a widget based on the semantic value;
obtain position data that characterizes a current pose or pose change of the device;
in accordance with a determination that the position data satisfies position criteria, display the widget on the display; and
in accordance with a determination that the position data does not satisfy the position criteria, forgo display of the widget.

15. The device of claim 14, wherein the position data indicates a speed of the device and the position data satisfies the position criteria when the speed of the device satisfies a speed criterion.

16. The device of claim 14, wherein the position data indicates an orientation of the device and the position data satisfies the position criteria when the orientation of the device satisfies an orientation criterion.

17. The device of claim 14, wherein the one or more processors are further to:
determine, based on the widget, the position criteria; and
determine whether the position data satisfies the position criteria.

18. The device of claim 14, wherein the one or more processors are to forgo display of the widget by displaying no widget.

19. The device of claim 14, wherein the one or more processors are to forgo display of the widget by:
selecting an alternate widget based on the semantic value; and
displaying the alternate widget.

20. A non-transitory memory having instructions encoded thereon which, when executed by one or more processors of a device including a display, cause the device to:
obtain a semantic value that is associated with a physical object within a physical environment of the device;
select a widget based on the semantic value;
obtain position data that characterizes a current pose or pose change of the device;
in accordance with a determination that the position data satisfies position criteria, display the widget on the display; and
in accordance with a determination that the position data does not satisfy the position criteria, forgo display of the widget.
